(19) United States
(12) Patent Application Publication
(10) Pub. No.: US 2025/0056454 A1
(43) Pub. Date: Feb. 13, 2025

(54) PROPAGATION DELAY COMPENSATION BASED ON TIMING ADVANCE IN SPLIT NODE ARCHITECTURE

(71) Applicant: Telefonaktiebolaget LM Ericsson (publ), Stockholm (SE)

(72) Inventors: Nianshan Shi, Järfälla (SE); Zhenhua Zou, Sollentuna (SE); Mohammed Yazid Lyazidi, London (GB)

(21) Appl. No.: 18/717,721

(22) PCT Filed: Dec. 21, 2022
(86) PCT No.: PCT/IB2022/062618

§ 371 Date: Jun. 7, 2024

Related U.S. Application Data
(60) Provisional application No. 63/295,611, filed on Dec. 31, 2021.

(51) Int. Cl. H04W 56/00; H04W 24/10

(52) U.S. Cl. CPC H04W 56/0045; H04W 24/10

(57) ABSTRACT

Embodiments include methods for a centralized unit (CU) of a radio access network (RAN) node. Such methods include sending, to a distributed unit (DU) of the RAN node, a request for one or more timing advance (TA) measurements for a user equipment (UE) with respect to one or more cells served by the DU. Such methods include receiving from the DU one or more responses that include the respective one or more TA measurements and for each received TA measurement, determining a corresponding downlink (DL) propagation delay (PD) between the DU and the UE. Other embodiments include complementary methods for a DU of a RAN node, as well as CUs and DUs configured to perform such methods.

### TECHNICAL FIELD

The present disclosure relates generally to the field of wireless networks and more specifically to techniques for compensating for propagation delay between a wireless network and a user equipment (UE), such as when the wireless network delivers highly accurate timing information to the UE.

### BACKGROUND

Industry 4.0 is a term used to refer to a current trend of automation and data exchange in manufacturing. It can include concepts and/or technologies such as cyber-physical systems, the Internet of things (IoT), cloud computing, and cognitive computing. Industry 4.0 is also referred to as the fourth industrial revolution or “14.0” for short.

One scenario or use case for Industry 4.0 is the so-called “smart factory”. Within modular structured smart factories, cyber-physical systems monitor physical processes, create a virtual copy of the physical world, and make decentralized decisions. Over the Internet of Things (IoT), cyber-physical systems communicate and cooperate with each other, and with humans, in real-time both internally and across organizational services offered and used by participants of a value chain of which the smart factory is a part. Such smart factory environment environments are also referred to as Industrial Internet of Things (IIoT).

Currently the fifth generation (“5G”) of cellular systems, also referred to as New Radio (NR), is being standardized within the Third-Generation Partnership Project (3GPP). NR is developed for maximum flexibility to support many different use cases. These include mobile broadband, machine type communication (MTC), ultra-reliable low-latency communications (URLLC), device-to-device (D2D), and other use cases related to IIOT and/or Industry 4.0. In order to extend NR applicability for such use cases, support for time synchronization in the 5G system via time sensitive network (TSN) has been defined in 3GPP TS 23.501 (v16.4.0).

At a high level, the 5G network architecture consists of a Next Generation radio access network (NG-RAN) and a 5G core network (5GC). The NG-RAN includes various gNodeB's (gNBs, also referred to as base stations) serving cells by which wireless devices (also referred to as user equipment, or UEs) communicate. The gNBs can be connected to the 5GC via one or more NG interfaces and can be connected to each other via one or more Xn interfaces. Each gNB can support frequency division duplexing (FDD) and/or time division duplexing (TDD).

Each gNB in the NG-RAN can include a central (or centralized) unit (CU or gNB-CU) and one or more distributed (or decentralized) units (DU or gNB-DU), which can be viewed as logical nodes. CUs host higher-layer protocols and perform various gNB functions such controlling the operation of DUs, which host lower-layer protocols and can include various subsets of the gNB functions. For example, a CU puts together system information blocks (SIBs) and provides them to a DU for broadcast in a cell. CUs and DUs communicate via an F1 interface, which is not visible outside of the gNB. CUs and DUs can include various circuitry needed to perform their respective functions, including processing circuitry, communication interface circuitry, power supply circuitry, etc. Each gNB may also include and/or be associated with one or more transmission reception points (TRPs). Although TRPs may be hardware units, they may also represent (or be represented by) logical partitions or relationships such as transmission configuration indicator (TCI) state, synchronization signal/PBCH (SSB) beams, spatial relations, etc.

To support IIoT uses cases, a 5G network (e.g., NG-RAN and 5GC) should be capable of delivering highly accurate timing information from an external TSN network to TSN endpoints connected to the 5G network, e.g., via UEs. For example, a UE can acquire 5G reference time by estimating a system frame number (SFN) boundary based on receiving network-transmitted reference signals (RS) and then updating its time based on network-provided timing information that relates the SFN boundary to 5G system clock (5GSC) time.

One problem in determining these timing relationships is the radio frequency (RF) propagation delay (PD) of the signal from the gNB to the UE, which is proportional to the propagation distance between gNB and UE. For example, a UE that is 300 m distant from the gNB antenna will experience a propagation delay of approximately one microsecond. Note that the propagation distance may be greater than the geographical (or line-of-sight, LOS) distance due to reflections of the signal from obstacles positioned between the gNB and the UE. The propagation distance may also be referred to as a “RF distance”.

As such, even if the gNB provides the UE with a 5GSC time, the TSN time derived by the UE may be inaccurate (e.g., offset) by the amount of the PD. Put differently, a TSN-5GSC timing relationship is only accurate up to the point of transmission of the TSN message by the gNB, e.g., at the gNB's transmission antenna(s). Furthermore, UEs may experience PDs that vary with time as the distance to the serving gNB changes and/or the serving gNB changes. Likewise, different UEs served by the same gNB may experience different PDs.

One conventional technique used for PD compensation is the network providing the UE a timing advance (TA) command in a MAC-layer control element (CE), which causes the UE to adjust or synchronize its UL transmission timing so that network (e.g., gNB) reception occurs at a desired time instance. In general, TA is an implementation variant of round trip time (RTT) measurement with the dynamic part of the TA command equal to two times the PD.

### SUMMARY

There are various problems, issues, and/or difficulties with the use of TA for PD compensation in the split CU-DU architecture. A DU serving a cell sends TA commands to UEs operating in the cell, with each TA command giving an incremental change of the UE's absolute TA of its UL transmissions in the cell. The associated CU may need to know the UE's absolute TA (i.e., accumulated from TA commands) for PD compensation, but may be unable to obtain an accurate value from the UE's serving DU for various reasons. This can lead to inaccurate PD compensation and corresponding inaccurate results from UE positioning methods that rely on TA measurements.

Embodiments of the present disclosure provide specific improvements to PD compensation in the CU-DU split node architecture, such as by facilitating solutions to overcome exemplary problems summarized above and described in more detail below.

Embodiments include various methods (e.g., procedures) for a CU of a radio access network (RAN) node.

These exemplary methods can include sending, to a DU of the RAN node, a request for one or more TA measurements for a UE with respect to one or more cells served by the DU. These exemplary methods can also include receiving, from the DU, one or more responses that include the respective one or more TA measurements. These exemplary methods can also include, for each received TA measurement, determining a corresponding DL propagation delay (PD) between the DU and the UE.

In some embodiments, the request indicates whether on-demand or periodic reporting of TA measurements is requested. In some of these embodiments, when the request indicates on-demand reporting, a single response including a single TA measurement is received from the DU. In other of these embodiments, when the request indicates periodic reporting, the request also includes a requested periodicity of the TA measurement. In such case, a plurality of responses including a respective plurality of periodic TA measurements are received from the DU spaced in time according to the requested periodicity.

In some embodiments, each response also includes an uncertainty associated with the TA measurement included in the response.

In some embodiments, the request includes an identifier associated with the requested TA measurements and each response includes the identifier. In some of these embodiments, these exemplary methods can also include sending, to the DU, a second request to stop or abort the TA measurements. The second request includes the identifier. In some variants, these exemplary methods can also include, after sending the request, receiving from a positioning node a further request for a TA measurement for the UE in relation to an enhanced cell ID (E-CID) positioning procedure. In such case, the second request is sent to the DU in response to the further request from the positioning node.

In some embodiments, the request also includes identifiers associated with the one or more cells for which TA measurements are requested and are provided in the respective responses. In other embodiments, the request does not include identifiers associated with the one or more cells and the respective responses include TA measurements on one of the following: the UE's primary cell (PCell), or the primary timing advance group (TAG) in the UE's master cell group (MCG).

In some embodiments, these exemplary methods can also include obtaining a previous TA measurement for the UE with respect to a first one of the cells served by the DU during an E-CID positioning procedure and upon subsequently initiating a reference time PD compensation procedure, determining validity of the previous TA measurement. The request is sent based on determining that the previous TA measurement is not valid. In some of these embodiments, these exemplary methods can also include refraining from sending the request based on determining that the previous TA measurement is valid. In such case, determining the DL PD is based on the previous TA measurement.

In some of these embodiments, these exemplary methods can also include initiating a timer upon obtaining the previous TA measurement. In such case, determining validity of the previous TA measurement is based on whether the timer has expired at the time of initiating the reference time PD compensation procedure.

In some embodiments, the requested TA measurements are for T_{ADV}=T_{gNB-RX}−T_{gNB-TX}, where parameters T_{gNB-RX} and T_{gNB-TX} are further defined herein.

In some embodiments, these exemplary methods can also include compensating a reference time based on the determined DL PD and sending, to the UE via the DU, a message including a relation between the compensated reference time and a radio interface event for the cell served by the DU. In some of these embodiments, the radio interface event is a boundary of a system frame number (SFN), the reference time is a system clock time for the SFN boundary at the DU transmitter, and the compensated reference time is the system clock time for the SFN boundary at the UE receiver.

Other embodiments include methods (e.g., procedures) for a DU of a RAN node.

These exemplary methods can include receiving, from a CU of the RAN node, a request for one or more TA measurements for a UE with respect to one or more cells served by the DU. These exemplary methods can also include obtaining one or more TA measurements for the UE in accordance with the request. These exemplary methods can also include sending, to the CU, one or more responses that include the respective one or more TA measurements.

In some embodiments, the request indicates whether on-demand or periodic reporting of TA measurements is requested. In some of these embodiments, when the request indicates on-demand reporting, a single response including a single TA measurement is received from the DU. In other of these embodiments, when the request indicates periodic reporting, the request also includes a requested periodicity of the TA measurement. In such case, a plurality of responses including a respective plurality of periodic TA measurements are received from the DU spaced in time according to the requested periodicity.

In some embodiments, each response also includes an uncertainty associated with the TA measurement included in the response.

In some embodiments, the request includes an identifier associated with the requested TA measurements and each response includes the identifier. In some of these embodiments, these exemplary methods can also include the following: receiving from the CU a second request to stop or abort the TA measurements, where the second request includes the identifier; and stopping or aborting the TA measurements in accordance with the second request. In some of these embodiments, the second request is received from the CU based on a further request from a positioning node for a TA measurement for the UE in relation to an E-CID positioning procedure.

In some embodiments, the request also includes identifiers associated with the one or more cells for which TA measurements are requested and are provided in the respective responses. In other embodiments, the request does not include identifiers associated with the one or more cells and the respective responses include TA measurements on one of the following: the UE's PCell, or the primary TAG in the UE's MCG.

In some embodiments, these exemplary methods can also include sending, to the CU in association with an E-CID positioning procedure, a previous TA measurement for the UE with respect to a first one of the cells served by the DU. In such case, the request is received after the previous TA measurement becomes invalid.

In some embodiments, obtaining the one or more TA measurements for the UE includes transmitting a PDCCH order in the UE's PCell and responsive to the PDCCH order, performing a random access (RA) procedure with the UE responsive to obtain a TA measurement.

In some of these embodiments, the PDCCH order is transmitted and the RA procedure is performed when the request indicates that on-demand reporting of TA measurements is requested. In other of these embodiments, when the request indicates that periodic reporting of TA measurements is requested, obtaining the one or more TA measurements for the UE includes, for each of the requested TA measurements, determining validity of a previous TA measurement sent most recently to the CU. In such case, the PDCCH order is transmitted and the RA procedure performed based on determining that the previous TA measurement is invalid.

In some variants of these embodiments, obtaining the one or more TA measurements for the UE includes, for each of the requested TA measurements, refraining from transmitting the PDCCH order and performing the RA procedure based on one or more of the following: determining that the previous TA measurement is valid; and an ongoing RA procedure with the UE related to a previous PDCCH order.

In some of these embodiments, the previous TA measurement is determined to be valid based on one or more of the following:
since sending the previous TA measurement to the CU, the DU has not transmitted any TA commands related to a PTAG that includes the UE's PCell; and
a timeAlignmentTimer associated with the PTAG has not been expired.

In some embodiments, each obtained TA measurement is for T_{ADV}=T_{gNB-RX}−T_{gNB-TX}, where parameters T_{gNB-RX} and T_{gNB-TX} are further defined herein:

In some embodiments, these exemplary methods can also include forwarding to the UE a message from the CU that includes a relation between a CU-compensated reference time and a radio interface event for the cell served by the DU. In some of these embodiments, the radio interface event is a boundary of a SFN, the reference time is compensated by the CU based on one or more of the TA measurements sent by the DU, and the compensated reference time is the system clock time for the SFN boundary at the UE receiver.

Other embodiments include CUs and DUs (or functional equivalents) of a RAN node (e.g., base station, eNB, gNB, ng-eNB, etc.) configured to perform operations corresponding to any of the exemplary methods described herein. Other embodiments include non-transitory, computer-readable media storing program instructions that, when executed by processing circuitry, configure such CUs and DUs to perform operations corresponding to any of the exemplary methods described herein.

These and other embodiments described herein enable CUs to acquire from DUs up-to-date TA measurements for UEs in a cell served by the DU, thereby facilitating accurate compensation for DL propagation delay in reference time information provided by the CU to these UEs. This can improve accuracy and/or reduce uncertainty of relationships between a 5GSC and a TSN GM, and thereby facilitate compliance with end-to-end accuracy requirements for delivery of TSN time information from TSN GM clocks to remotely located end stations connected to a 5G network. This can be particularly beneficial for IIOT devices in a factory setting that may have strict accuracy requirements for which violation could result in harm to workers and/or factory operations. Embodiments also facilitate coexistence between E-CID positioning procedures and DL propagation delay compensation procedures needing or using TA measurements for the same UE(s).

These and other objects, features, and advantages of embodiments of the present disclosure will become apparent upon reading the following Detailed Description in view of the Drawings briefly summarized below.

### BRIEF DESCRIPTION OF THE DRAWINGS

FIG. 1 is a block diagram illustrating a Centralized Time-Sensitive Networking (TSN) configuration model, as specified in IEEE 802.1Qbv-2015.

FIG. 2 is a block diagram illustrating a Fully Centralized TSN configuration model, as specified in IEEE 802.1Qbv-2015.

FIG. 3 is a block diagram illustrating an exemplary arrangement for interworking between a 5G network and an exemplary fully centralized TSN network architecture.

FIG. 4 is a high-level block diagram of an exemplary arrangement in which a 5G network delivers timing references from a TSN to TSN end stations connected to the 5G network, according to various embodiments of the present disclosure.

FIG. 5 illustrates an exemplary reference time update procedure between a UE and a serving network node (e.g., gNB).

FIG. 6 shows an ASN.1 data structure for an exemplary ReferenceTimeInfo information element (IE) used to provide the reference time to a UE.

FIG. 7 illustrates an enhanced round-trip-time (RTT) determination procedure.

FIG. 8 is a flow diagram of an exemplary method (e.g., procedure) for a CU, according to various embodiments of the present disclosure.

FIG. 9 is a flow diagram of an exemplary method (e.g., procedure) for a DU, according to various embodiments of the present disclosure.

FIG. 10 illustrates a high-level views of an exemplary 5G/NR network architecture, according to various embodiments of the present disclosure.

FIG. 11 shows a communication system according to various embodiments of the present disclosure.

FIG. 12 shows a UE according to various embodiments of the present disclosure.

FIG. 13 shows a network node according to various embodiments of the present disclosure.

FIG. 14 shows host computing system according to various embodiments of the present disclosure.

FIG. 15 is a block diagram of a virtualization environment in which functions implemented by some embodiments of the present disclosure may be virtualized.

FIG. 16 illustrates communication between a host computing system, a network node, and a UE via multiple connections, at least one of which is wireless, according to various embodiments of the present disclosure.

### DETAILED DESCRIPTION

Some of the embodiments summarized above will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node (or component thereof such as MT or DU), a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), etc. A core network node can also be a node that implements a particular core network function (NF), such as an access and mobility management function (AMF), a session management function (SMF), a user plane function (UPF), a Service Capability Exposure Function (SCEF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, the term “node” (without any prefix) can be any type of node that is capable of operating in or with a wireless network (including a RAN and/or a core network), including a radio access node (or equivalent term), core network node, or wireless device. However, the term “node” may be limited to a particular type of node (e.g., radio access node) based on its particular characteristics in any context of use.

Note that the description given herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

Use cases associated with Industry 4.0 include simpler ones such as plant measurement as well as more difficult ones such as precise motion control in a robotized factory cell. To address these requirements, the IEEE 802.1 working group (particularly, task group TSN) has developed a Time Sensitive Networking (TSN) standard. TSN is based on the IEEE 802.3 Ethernet standard, a wired communication standard that is designed for “best effort” quality of service (QOS). TSN describes a collection of features intended to make legacy Ethernet performance more deterministic, such as time synchronization, bounded low latency, ultra-reliability, and network configuration and management.

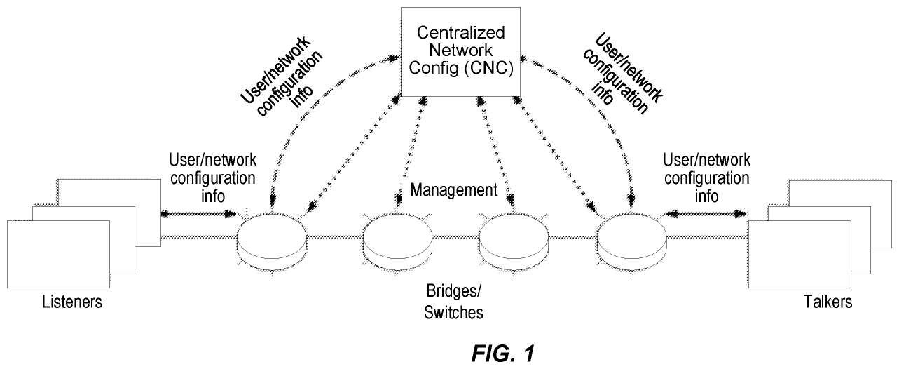

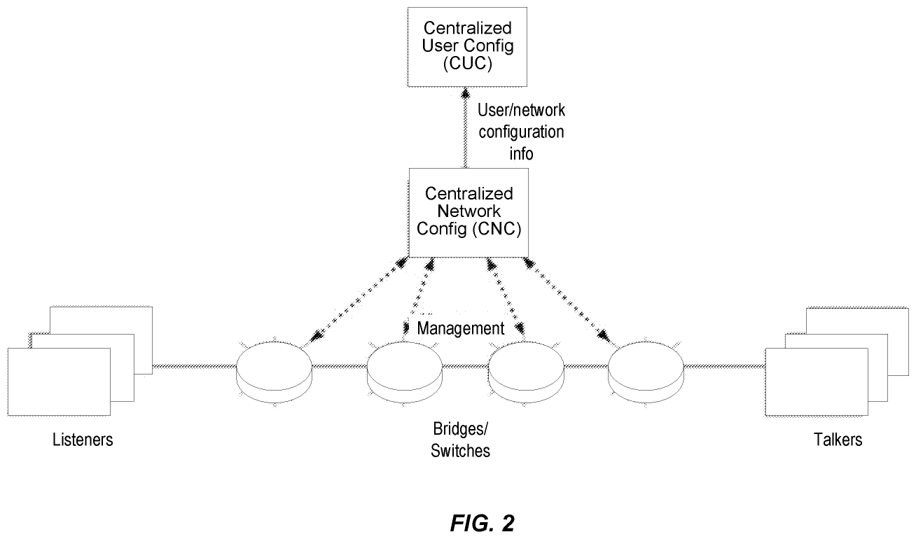

FIGS. 1-2 are block diagrams that respectively illustrate Centralized and Fully Centralized TSN configuration models, as specified in IEEE Std. 802.1Qbv-2015. Within a TSN network, the communication endpoints are called “Talker” and “Listener.” All the switches and/or bridges between a Talker and a Listener must support certain TSN features, such as time synchronization. A “TSN domain” includes all nodes that are synchronized in the network, and TSN communication is only possible within such a TSN domain.

The communication between Talker and Listener is in streams. Each stream is based on data rate and latency requirements of an application implemented at both Talker and Listener.

Some TSN features require a central management entity called Centralized Network Configuration (CNC), as shown in FIG. 1. The CNC can use, for example, Netconf and YANG models to configure the switches in the network for each TSN stream.

The fully centralized model shown in FIG. 2 also includes a Centralized User Configuration (CUC) entity used as a point of contact for Listener and Talker. The CUC collects stream requirements and endpoint capabilities from the devices and communicates with the CNC directly. Further details about TSN configuration are given in IEEE 802.1Qcc.

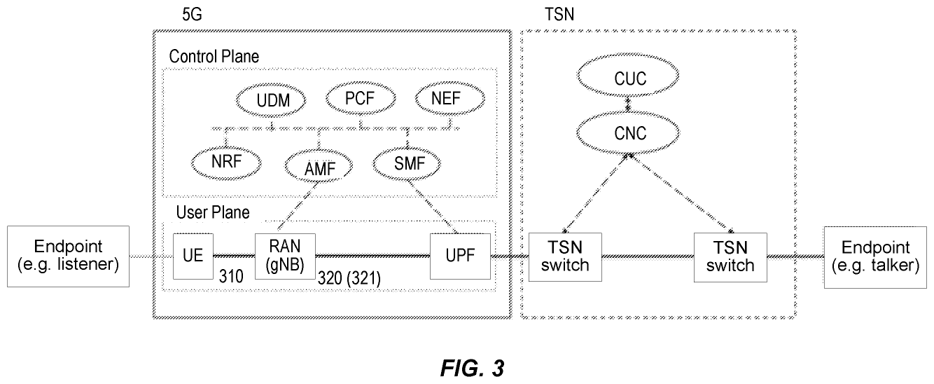

FIG. 3 is a block diagram illustrating an exemplary division of the 5G network architecture into control plane (CP) and data (or user) plane (UP) functionality. For example, a UE (310) can communicate data packets to a device and/or application on an external network (e.g., the Internet) by sending them via the UE's serving gNB (321) in the NG-RAN (320) to a user plane function (UPF) in the 5GC. The UPF provides an interface between the 5GC and external networks.

CP functionality can operate cooperatively with the UP functionality. CP functions shown in FIG. 3 include an access management function (AMF), a session management function (SMF), a network exposure function (NEF), a policy control function (PCF), a network repository function (NRF), and a unified data management (UDM) function. The AMF can communicate with the RAN via N2 logical interface, which can be carried over an NG interface between gNB and 5GC. UPF and SMF can communicate via N4 logical interface.

FIG. 3 also shows interworking between the 5G network architecture and an exemplary fully centralized TSN network architecture. In the following discussion, a device connected to the 5G network is referred to as 5G endpoint, and a device connected to the TSN domain is referred to as TSN endpoint. The arrangement shown in FIG. 3 includes a Talker TSN endpoint and a Listener 5G endpoint connected to a UE. In other arrangements, a UE can instead be connected to a TSN network with at least one TSN bridge and at least one TSN endpoint. In this configuration, the UE can be part of a TSN-5G gateway.

The TSN can include a grandmaster clock (TSN GM) that serves as a definitive timing source for TSN endpoints. In FIG. 3, the 5G network should appear to the connected TSN as a switch or bridge that delivers the TSN GM timing to the connected endpoints in compliance with the requirements in IEEE 802.1AS. However, the 5G network does use the TSN GM as its own timing source, but instead relies on a 5G system clock (5GSC) that is distributed among the various network nodes or functions. As such, one or more timing relationships between TSN GM and 5GSC may need to be determined and/or derived to facilitate transit of the TSN GSM to the connected end station in a compliant manner.

Time synchronization has been common practice for cellular networks of different generations and is an integral part of operating 5G networks. The NG-RAN components themselves are also time synchronized, e.g., for advanced radio transmission such as synchronized Time Division Duplex (TDD) operation, cooperative multipoint (COMP) transmission, or carrier aggregation (CA). The new 5G capability introduced when integrating 5G systems (5GS) and TSNs is to provide 5G internal clock (reference time) delivery as a service over the 5GS.

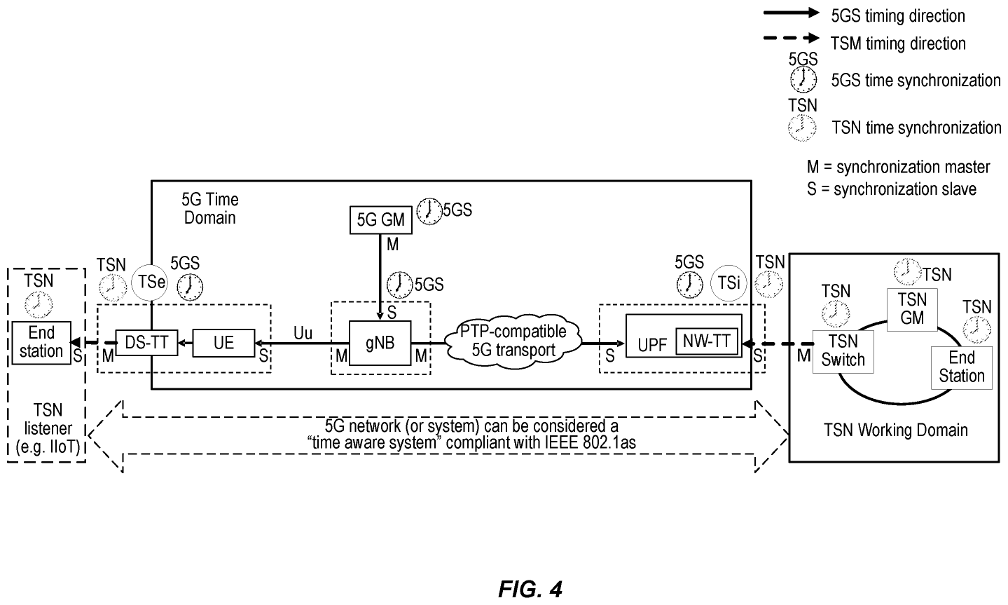

FIG. 4 is a high-level block diagram of an exemplary arrangement in which a 5G network delivers timing references from a TSN network to TSN end stations connected to the 5G network. The TSN source network is shown as a TSN Working Domain that includes a TSN GM, an end station, and a TSN Switch. In this exemplary arrangement, the 5G network is integrated with the external TSN network as a TSN bridge, such as shown in other figures described above. Furthermore, in this arrangement, the 5G network can be modelled as an IEEE 802.1AS compliant entity; for TSN synchronization, the end-to-end 5G network can be considered as an IEEE 802.1AS “time-aware system”.

However, only the TSN Translators (TTs) at the edges of the 5G network need to support the IEEE 802.1AS operations. This includes a network side TSN translator (NW-TT) at the user plane function (UPF) and a device-side TSN translator (DS-TT) at the UE. Ingress timestamping (“TSi”) is performed by the NW-TT when an external TSN clock (e.g., timing) signal is received by from the TSN Working Domain. Likewise, egress timestamping (“TSe”) is performed by the DS-TT when that TSN clock signal arrives at a UE. In addition to ingress and egress timestamping, the TTs can support other 802.1AS functions such as generalized precision time protocol (gPTP), Best Master Clock Algorithm (BMCA), rateRatio, etc.

More specifically, upon reception of a downlink gPTP message, the NW-TT makes an ingress timestamp (TSi) for each gPTP event (Sync) message. The UPF then forwards the gPTP message from TSN network to the UEs via all UPF-terminated PDU sessions that the UEs have established to the TSN network. All gPTP messages are transmitted on a quality of service (QOS) flow that complies with the residence time upper bound requirement specified in IEEE 802.1AS. The UE receives the gPTP messages and forwards them to the DS-TT. The DS-TT then makes an egress timestamp (TSe) for the gPTP event (Sync) messages for the TSN domain (e.g., the endpoints).

The difference between TSi and TSe reflects the residence time of the gPTP message within the 5G network, expressed in 5GSC time. Put differently, if gPTP message indicating TSN time “X” is stamped with 5G system clock (5GSC) time “Y” at ingress and 5GSC time “Z” at egress, the end stations can adjust TSN time “X” delivered to the end station by the residence time Z-Y. More specifically, the DS-TT calculates and adds the measured residence time between the TTs into the Correction Field (CF) of each gPTP event (Sync) message. As such, the relative accuracy of the 5G residence time measured between ingress and egress is essential for accurate TSN GM clock timing information delivered over 5G networks.

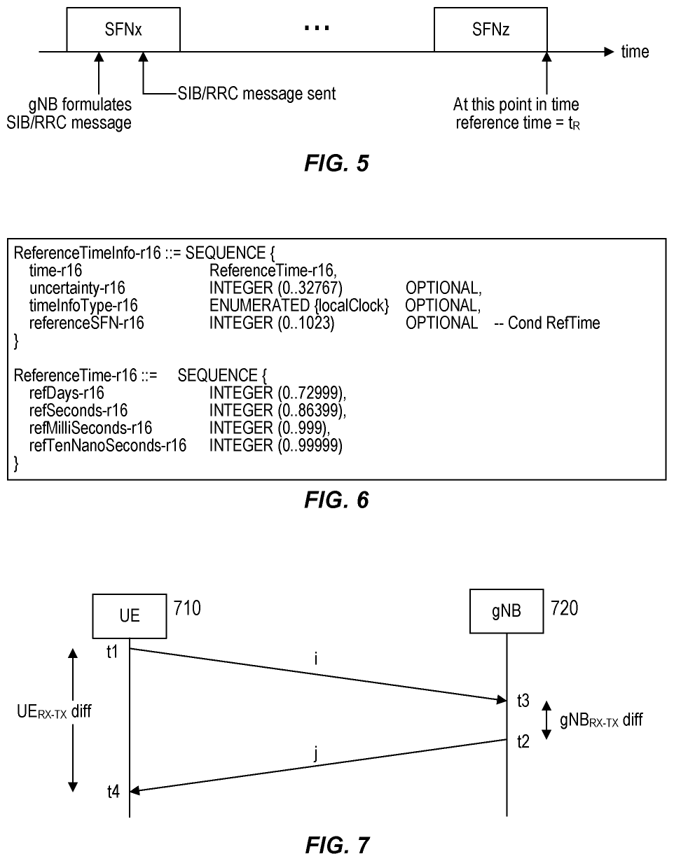

In the 5G network, the UE, the gNB, the UPF, the NW-TT, and the DS-TT are synchronized with a grandmaster 5GSC (“5G GM” in FIG. 5), either directly or indirectly. In general, the 5GSC is made available to all UP nodes in the 5G network via a PTP-compatible transport network. Likewise, 5GSC is made available to UEs via signaling of absolute timing of radio frames. In FIG. 5, solid lines are used to denote flow of 5GSC synchronization between respective synchronization master (“M”) and slave (“S”) elements in the 5G network. Likewise, dashed lines are used to denote flow of TSN GM synchronization between respective synchronization master (“M”) and slave (“S”) elements in the TSN domain. In general, the two synchronization processes can be independent from each other and the gNB only needs to be synchronized to the 5GSC.

To summarize, the time synchronization solution defined in 3GPP TS 23.501 (v16.4.0) only requires NG-RAN nodes (e.g., gNBs) to be synchronized to the 5G network reference time (i.e., based on 5GSC) while TSN GM timing is delivered to UEs and endpoints transparently through the 5G network using gPTP signaling. For 5GSC synchronization, a UE relies on its serving gNB providing reference time periodically, either via broadcast or unicast signaling. For example, reference time information can be delivered via broadcast in SI block SIB9 or via unicast via the RRC message DownlinkInformationTransfer. To support time sensitive communications, a reference time granularity of 10 ns is defined in 3GPP TS 23.501.

There are two synchronization processes running in parallel in the integrated 5G-TSN system: a 5G system internal synchronization process involving distribution of a 5GSC required to realize ingress to egress traffic delay targets for the 5GS; and a TSN synchronization process needed to realize synchronization between a TSN GM source and devices reachable through the 5GS. The two synchronization processes can be considered independent from each other.

Once the 5G reference time is acquired by a gNB (e.g., from a GPS receiver) it is sent to different nodes in the 5G network with the goal of introducing as little synchronicity error (or uncertainty) as possible when distributing it. The distribution of 5G reference time information to UEs uses existing synchronized operation inherent to the 5G RAN (also referred to as NG-RAN). This enables end-to-end time synchronization for industrial applications communication services running over 5G system.

A gNB maintains its acquired 5G reference time on an ongoing basis as well as periodically projecting the 5G reference time to a specific reference point in the radio interface frame structure, e.g., at the end of a frame having a particular system frame number (SFN). The relation-ship between 5G reference time and SFN is valid at the gNB's Antenna Reference Point (ARP).

FIG. 5 illustrates an exemplary reference time update procedure between a UE and a serving gNB. In SFNx, the gNB formulates and sends a reference time message with a 5G reference time value (tR) and a corresponding reference event on the radio interface for the cell. The gNB can broadcast the reference time message in system information block 9 (SIB9) or send it to individual UEs, as a unicast RRC message such as DLInformationTransfer.

As briefly mentioned above, each gNB in the NG-RAN can include a CU (or gNB-CU) and one or more DUs (or gNB-DUs), which can be viewed as logical nodes. In the context of providing reference time to UEs, the SIB and RRC unicast messages are generated by a CU and, preferably, the reference event is referenced on the radio interface provided by the DU. For unicast delivery, a DU reports 5GSC at reference event (e.g., SFN) to a CU, which generates the unicast RRC message including the reported timing relationship.

FIG. 6 shows an ASN.1 data structure for an exemplary ReferenceTimeInfo information element (IE) used to provide the reference time to a UE. The IE includes a time field that is defined as a ReferenceTime structure that includes fields for days, seconds, milliseconds (ms), and tens of nanoseconds (ns). The IE also includes a referenceSFN that defines the reference event on the radio interface. If the timeInfoType is not included in the IE, the time field indicates the GPS time and the origin of the time field is 00:00:00 on Gregorian calendar date 6 Jan. 1980 (i.e., start of GPS time). If timeInfoType is set to localClock, the origin of the time is unspecified.

In addition, the uncertainty field reflects a level of uncertainty in the provided timing relationship. This includes two factors: 1) the accuracy with which a gNB implementation can ensure that the indicated reference time corresponding to reference point will reflect the actual time when that reference point occurs at the antenna reference point, and 2) the accuracy with which the 5G reference time is acquired by the gNB. The first factor is gNB-implementation specific but is expected to be negligible and is considered in the following discussion. The actual uncertainty indicated by the uncertainty field is 25 ns multiplied by the integer value in this field. If this field is absent, the uncertainty is unspecified.

In the example shown in FIG. 5, the reference event is the end of SFNz following SFNx. For broadcast in SIB9, the value of SFNz is implicitly indicated as the SFN boundary at or immediately after the ending boundary of the SI-window in which SIB9 is transmitted. When the reference time is sent in a unicast RRC message (e.g., according to FIG. 6), the SFN indicated by the referenceSFN field is in the UE's PCell. The UE receives the reference time message in advance of the reference event and subsequently synchronizes its internal clock with the reference time tR that occurs at the end of SFNz.

A DU can overwrite SIB9 for broadcast because SIB9 is not encrypted by the CU. The reason for a DU to modify time is that the gNB's clock is located at the DU and there is an unknown, unexpected, and/or varying transmission delay between CU and DU. Even though the CU can compensate for this delay when setting time in the message sent to the DU, the compensation may be inaccurate. Thus, it is preferable to allow the DU to overwrite the received time and/or to generate SIB9 on its own.

A unicast DLInformationTransfer message containing ReferenceTimeInfo message is encrypted by the CU before sending to the DU. The CU can request the DU to deliver the accurate reference time information either on demand or by a periodic reporting, as specified in 3GPP TS 38.473 (v16.7.0) section 9.2.11.

One problem that arises in delivering accurate timing information to UEs is radio frequency (RF) propagation delay (PD) of the signal from gNB to UE, which is proportional to the distance between gNB and UE. Put differently, the biggest 5GS synchronization error is due to the PD from gNB to UE when delivering the 5G internal clock to the UE via the radio (Uu) interface. For example, a UE that is 300 m distant from the gNB antenna will experience a propagation delay of approximately one microsecond. As such, even if the gNB provides the UE with a 5GSC time, the TSN time derived by the UE may be inaccurate (e.g., offset) by the amount of the PD. Put differently, a TSN-5GSC timing relationship is only accurate up to the point of transmission of the TSN message by the gNB, e.g., at the gNB's antenna reference point (ARP).

Time synchronization requirements from vertical industries have been defined in 3GPP TS 22.104 (v18.2.0). Table 1 below (5.6.2-1 from 3GPP TS 22.104) shows a diverse set of clock synchronization service performance requirements for 5G system, with note references following Table 1.

TABLE 1

| | Number UEs per | | | | | |
|---|---|---|---|---|---|---|
| User-specific | communication | 5GS sync. | | | | |
| clock sync. | group for clock | budget reqmt. | | | | |
| accuracy level | sync. | (Note 1) | | Service area | | Scenario |
| 1 | ≤300 | ≤900 | ns | ≤100 m × | | Motion control |
| | | | | 100 m | | (A.2.2.1) |
| | | | | | | Control-to-control |
| | | | | | | communication for |
| | | | | | | industrial controller |
| | | | | | | (A.2.2.2) |
| 2 | ≤300 | ≤900 | ns | ≤1,000 m × | | Control-to-control |
| | | | | 100 m | | communication for |
| | | | | | | industrial controller |
| | | | | | | (A.2.2.2) |
| 3 | ≤10 | <10 | μs | ≤2,500 | m² | High data rate video |
| | | | | | | streaming |
| 3a | ≤100 | <1 | μs | ≤10 | km² | AVPROD |
| | | | | | | synchronisation and |
| | | | | | | packet timing |
| 4 | ≤100 | <1 | μs | <20 | km² | Smart Grid: |
| | | | | | | synchronicity |
| | | | | | | between PMUs |
| 4a | ≤100 | <250 ns to 1 μs | | <20 | km² | Smart Grid: IEC |
| | | | | | | 61850-9-2 Sampled |
| | | | | | | Values |
| 4b | ≤100 | <10-20 | μs | <20 | km² | Smart Grid: IEC |
| | | | | | | 61850-9-2 Sampled |
| | | | | | | Values - Power |
| | | | | | | system protection in |
| | | | | | | digital substation |
| 4c | 54/km² (note 2) | <10 | μs | several | | Smart Grid: |
| | 78/km² (note 3) | | | km² | | Intelligent |
| | | | | | | Distributed Feeder |
| | | | | | | Automation |
| | | | | | | (A.4.4.3) |
| 4d | ≤100 | <1 | ms | <20 | km² | Smart Grid: IEC |
| | | | | | | 61850-9-2 Sampled |
| | | | | | | Values - Event |
| | | | | | | reporting and |
| | | | | | | Disturbance |
| | | | | | | recording |
| 5 | ≤10 | <50 | μs | 400 | km | Telesurgery (A.6.2) |

and telediagnosis
(A.6.3)
(Note 1)
Clock synchronicity requirement refers to the clock synchronicity budget for the 5G system, as described in 3GPP TS 22.104 section 5.6.1.
(note 2)
When the distributed terminals are deployed along overhead line, about 54 terminals will be distributed along overhead lines in one square km. The resulting power load density is 20 MW/km².
(note 3)
When the distributed terminals are deployed in power distribution cabinets, there are about 78 terminals per square km. The resulting power load density is 20 MW/km².

3GPP has defined time synchronization error budgets for a single radio (Uu) interface in view of the performance requirements shown in Table 1. Table 2 below shows Uu interface error or uncertainty budgets for the most demanding synchronization requirements in Table 1. The two listed scenarios represent a general wide area deployment and a local deployment area.

TABLE 2

| Scenario | Single Uu interface Budget |
|---|---|
| Control-to-Control | ±145 ns to ±275 ns |
| Smart Grid | ±795 ns to ±845 ns |

Applicants have recognized that it is not possible for a UE to meet the synchronization service performance requirements shown in Table 1 and error or uncertainty budgets shown in Table 2, without the UE applying accurate PD compensation to the 5GSC timing transferred from the gNB over the Uu interface.

As briefly mentioned above, TA commands are conventionally used for UE UL transmission synchronization in NR and earlier-generation LTE networks. TA correction may be needed due to changes in the UE propagation environment and/or distance between the UE and the serving base station (e.g., gNB). At connection setup, an absolute timing correction is communicated to a UE using a medium access control (MAC) random access response (RAR) element. After connection setup, a relative timing correction can be sent to a UE using a MAC control element (CE).

As indicated in 3GPP TS 38.211 (v16.7.0) section 4.3.1, UE transmission of UL frame number i shall start T_{TA}=(N_{TA}+N_{TA,offset}) Tc before the start of UE reception of the corresponding DL frame, where N_{TA,offset} is specified in 3GPP TS 38.213 (v16.7.0) and N_{TA} is updated according to 38.213 section 4.2 based on the received TA command MAC CE(s). For a numerology u and subcarrier spacing (SCS) of 2^{μ}·15 kHz, the TA command for a timing advance group (TAG, i.e., of cells) indicates the change of the UL timing relative to the current UL timing for the TAG in multiples of 1024·T_{C}/2^{μ}, where T_{C}=1/(Δfₘₐₓ·N_{f}), Δfₘₐₓ=480·10³ Hz, and N_{f}=4096.

DL propagation delay (PD) can be estimated for a given UE by (a) summing the TA value indicated by the initial absolute TA value and all subsequent relative TA values, and (b) taking some portion of the resulting total TA value to represent DL-only delays. For example, 50% could be used assuming the DL and UL propagation delays are essentially the same. The estimated PD can then be used to understand time synchronization dynamics, e.g., for accurately tracking and/or compensating the value of a 5GSC at the UE side relative to the value of that clock in some other network node.

A drawback of using TA for these purposes is that due to various implementation inaccuracies in transmit timing and reception timing at gNB and UE, it introduces up to 540 ns uncertainty in the DL PD determined for a Uu interface based on NR Rel-15/Rel-16 implementation requirements. Nevertheless, TA-based propagation delay compensation can meet the requirements for the smart grid scenario in Table 2 above.

Furthermore, 3GPP has agreed that the legacy TA-based mechanism will continue to be supported and that the gNB can pre-compensate PD information with measured TA. For example, if the gNB indicates to the UE not to compensate PD based on the legacy TA, then this implies that the gNB has pre-compensated PD information accordingly.

Also, 3GPP has agreed that the 5GC should provide the NG-RAN a time synchronization error budget for a Uu interface to a UE. The rationale is that this information enables NG-RAN to appropriately configure radio resources for each UE to achieve a corresponding time synchronization error budget. This has various effects on PD compensation, as explained below.

When the error budget is much larger than the maximum PD in a cell, there is no need for the NG-RAN to apply PD compensation. When the error budget is smaller but still larger than ˜500 ns, then the NG-RAN can configure legacy TA-based PD compensation, which compensation does not require separate RS configurations nor any additional information exchange (since TA is carried in existing MAC CE). When the error budget is below ˜500 ns, then the NG-RAN should configure RTT-based PD compensation. In general, smaller error budgets require greater radio resources for the reference signals used for PD compensation (e.g., more frequent RS, more repetitions).

FIG. 7 illustrates an enhanced RTT-based PD compensation procedure between a UE (710) and a gNB (720). It can be summarized as follows:
UE transmits an UL frame i and records the transmission time as t₁.
gNB receives UL frame i and records the time of arrival of the first detected path as t₃.
gNB transmits a DL frame j to the UE, and records transmission time as t₂.
UE receives DL frame j and records the time of arrival of the first detected path as t₄.
The following calculations are performed in the UE and gNB, respectively:
   UE_{Rx-Tx} diff=t₄−t_{1; and}
   gNB_{Rx-Tx} diff=t₃−t₂. This quantity can be positive or negative depending on the whether gNB transmits the DL frame before or after receiving the UL frame.
PD can be calculated as RTT/2, where RTT=(t₃−t₂)+ (t₄−t₁).
   In one variant, the gNB delivers the gNB Rx-Tx difference (t₃−t₂) to the UE and the UE calculates the RTT and PD. In other variant, the UE delivers the UE Rx-Tx difference (t₃−t₂) to the gNB and the gNB calculates the RTT and PD. In general, this technique can substantially reduce the uncertainty of the estimated DL PD from the 540 ns value mentioned above.

In Rel-17, the 5GS expands support for time synchronization and time-sensitive communications to any application. The 5GS architecture enables any Application Function (AF) in the same or different trust domain to provide its requirements for QoS, traffic characteristics for QoS scheduling optimization, and time synchronization activation and deactivation. If the AF is in a different trust domain than the 5GS, then it provides input via network exposure function (NEF) application programming interface (API). If the AF is in the same trust domain as the 5GS, then it provides input directly via the Time Sensitive communication Time Synchronization function (TSCTSF).

3GPP TS 23.501 (v17.2.0) section 5.27.1.9 specifies that the AF may request to use the 5G access stratum (AS) as a time synchronization distribution method and it may include time synchronization error budget in the request. If the AF includes a time synchronization error budget, the TSCTSF uses this information to derive an error budget available for the NG-RAN to provide the 5GS AS time to each targeted UE via the Uu interface (referred to as Uu time synchronization error budget hereafter). The TSCTSF takes the following into account when deriving the Uu time synchronization error budget:
selected time synchronization distribution method (5G AS time distribution or (g) PTP based time distribution);
whether 5GS operates as a boundary clock and acts as a GM or whether a clock connected to DS-TT/NW-TT acts as GM in case of (g) PTP based time distribution;
PTP port states in case of (g) PTP based time distribution; and
CN and Device parts of the time synchronization error budget (which may be predefined, or calculated by the 5GS by means that are based on implementation).

If the AF has not included a time synchronization error budget, the TSCTSF uses preconfigured information to derive the Uu time synchronization error budget. TSCTSF provides a time distribution indication and the Uu time synchronization error budget to NG-RAN as described in 3GPP TS 23.502 (v17.2.0) section 4.15.9.4. The NG-RAN provides the 5GS AS time to the UE according to the Uu interface time synchronization error budget provided by the TSCTSF (if supported by UE and NG-RAN).

3GPP standards provide various methods for positioning (e.g., determining the position of, locating, and/or determining the location of) UEs operating in NR networks. In general, a positioning node configures a target device (e.g., UE) and/or NG-RAN nodes (e.g., gNB, ng-eNB, or RAN node dedicated for positioning measurements) to perform one or more positioning measurements to support a positioning method. The position can be determined by the target device, the measuring node, and/or the positioning node based on the positioning measurements.

One positioning method supported in NR is Enhanced Cell ID (E-CID), which uses certain information to associate the UE with the geographical area of its serving cell and then additional information to determine a more accurate UE position. Measurements used in E-CID include angle-of arrival (AoA, by network), UE Rx-Tx time difference, TA, reference signal received power (RSRP), and RS received quality (RSRQ).

3GPP recently agreed to support a new timing advance measurement (called “T_{ADV}” or denoted T_{ADV}) for E-CID positioning. In particular, T_{ADV}=T_{gNB-RX}−T_{gNB-TX}, where T_{gNB-RX} is the TRP UL receive timing (i.e., first detected path in time) of subframe i containing physical random access channel (PRACH) transmitted by the UE and T_{gNB-TX} is the TRP DL transmit timing of subframe j that is closest in time to subframe i received from the UE. The detected PRACH is used to determine the start of one subframe containing that PRACH.

In the context of NR E-CID positioning, NR TADV has been introduced in the NRPPa protocol between the positioning server (also referred to as location management function or LMF) and NG-RAN nodes. Because of the CU-DU split and the fact that TADV is determined by a MAC CE message, the NR TADV measurement was also introduced in F1AP interface between CU and DU. DU reporting of the NR TADV is thus a consequence of the initial request coming from the LMF to the NG-RAN.

To initiate E-CID measurements, a CU can send a DU an E-CID MEASUREMENT INITIATION REQUEST message via the F1AP interface. Table 3 below shows exemplary contents of this message. The E-CID Measurement Quantities field is specified as an enumerated set of values, of which one is “NR Timing Advance”. The DU responds with an E-CID MEASUREMENT INITIATION RESPONSE message, with some exemplary contents shown in Table 4 below. Table 5 also shows exemplary contents of the E-CID Measurement Result field, which includes a Value Timing Advance NR sub-field that carries the TADV value.

TABLE 3

| | | | Semantics |
|---|---|---|---|
| IE/Group Name | Range | IE type/ref. | description |
| Message Type | | 9.3.1.1 | |
| gNB-CU UE F1AP ID | | 9.3.1.4 | |
| gNB-DU UE F1AP ID | | 9.3.1.5 | |
| LMF UE Measurement ID | | INTEGER (1 . . . 256, . . .) | |
| RAN UE Measurement ID | | INTEGER (1 . . . 256, . . .) | |
| E-CID Report | | ENUMERATED | |
| Characteristics | | (OnDemand, Periodic, . . .) | |
| E-CID Measurement | | ENUMERATED (120 ms, | |
| Periodicity | | 240 ms, 480 ms, 640 ms, | |
| | | 1024 ms, 2048 ms, 5120 ms, | |
| | | 10240 ms, 1 min, 6 min, 12 min, | |
| | | 30 min, . . . , 20480 ms, | |
| | | 40960 ms) | |
| E-CID Measurement | 1 . . . | | |
| Quantities | <maxnoofMeasE-CID> | | |
| >E-CID Measurement | | ENUMERATED (Default, | If “Default” is the only |
| Quantities Item | | NR Angle of Arrival, . . . , | requested measurement |
| | | NR Timing Advance) | quantity, it indicates |
| | | | that the Measured |
| | | | Results List IE need not |
| | | | be included in response |
| | | | or reporting messages. |

TABLE 4

| | | | |
|---|---|---|---|
| | | | Semantics |
| IE/Group Name | Pres. | IE type/ref. | description |

| | | |
|---|---|---|
| Message Type | M | 9.3.1.1 |
| gNB-CU UE F1AP ID | M | 9.3.1.4 |
| gNB-DU UE F1AP ID | M | 9.3.1.5 |
| LMF UE Measurement ID | M | INTEGER (1 . . . 256, . . .) |
| RAN UE Measurement ID | M | INTEGER (1 . . . 256, . . .) |
| E-CID Measurement Result | O | 9.3.1.199 |
| Cell Portion ID | O | 9.3.1.200 |
| Criticality Diagnostics | O | 9.3.1.3 |

TABLE 5

| | | | | Semantics |
|---|---|---|---|---|
| IE/Group Name | Pres. | Range | IE type/ref. | Description |
| Geographical Coordinates | O | | 9.3.1.184 | Configured estimated |
| | | | | geographical position |
| | | | | of the antenna of the |
| | | | | cell. |
| Measured Results List | | 0 . . . 1 | | |
| >E-CID Measured Results Item | | 1 . . . | | |
| | | <maxnoMeasE-CID> | | |
| >>CHOICE Measured Results | M | | | |
| Value | | | | |
| >>>Value Angle of Arrival | M | | UL Angle of | |
| NR | | | Arrival 9.3.1.167 | |
| >>> Value Timing | M | | INTEGER | As defined in TS |
| Advance NR | | | (0 . . . 7690) | 38.215 [42] |

In the split-gNB architecture, a DU serving a cell sends TA commands to UEs operating in the cell, with each TA command giving an incremental change of a UE's absolute TA of its UL transmissions in the cell. With the legacy-TA based PDC in which gNB pre-compensates the propagation delay, the CU in the split-gNB architecture needs to know the accumulated timing advance (i.e., T_{TA} discussed above) that the UE has applied. Even so, the CU may be unable to obtain an accurate value from the UE's serving DU for various reasons. This can lead to inaccurate PD compensation and corresponding inaccurate results from positioning methods such as E-CID) that rely on TA measurements.

For example, a UE may not properly receive all TA command MAC CEs sent by a DU, or a DU may not properly receive UE acknowledgements of TA command MAC CEs received by the UE. In any case, the DU can have a misunderstanding about which of the sent TA command MAC CEs were received and applied by the UE. In such case, the counting of the accumulated timing advance (i.e., T_{TA}) becomes mismatched at the UE and the DU, such that the DU does not provide an accurate value to the CU.

While the messages defined in Tables 3-5 above provide a way for a CU to request and receive TADV for a UE in the context of an E-CID procedure, it is unclear how the CU obtains an accurate timing advance from the DU in other scenarios-when a trigger comes from the positioning server (e.g., LMF) and not from the CU itself. Also, when there is an ongoing E-CID procedure requesting TA, a coexistence mechanism is needed at the gNB to ensure that procedures used to report needed measurement do not impact each other (e.g., cause a failure) nor add unnecessary complexity to the DU operations.

Embodiments of the present disclosure address these and other problems, issues, and/or difficulties by providing techniques for CUs to acquire from DUs up-to-date TA measurements for UEs in a cell served by the DU, thereby facilitating accurate compensation for DL propagation delay in reference time information provided by the CU to these UEs. Certain embodiments are particularly applicable to scenarios in which there are no pending E-CID positioning procedures needing or using TA measurements for the same UE(s). Other embodiments are particularly applicable to scenarios in which an E-CID positioning procedure is initiated during an ongoing DL propagation delay compensation procedure, or vice versa, with both procedures needing TA measurements for the same UE(s).

Embodiments can provide various benefits and/or advantages. By enabling CUs to acquire from DUs up-to-date TA measurements for UEs in a cell served by the DU, embodiments facilitate accurate compensation for DL propagation delay in reference time information provided by the CU to these UEs over the radio (Uu) interface. This can improve accuracy and/or reduce uncertainty of timing relationships and thereby facilitate compliance with end-to-end accuracy requirements for delivery of TSN time information to remotely located end stations connected to a 5G network. This can be particularly beneficial for IIOT devices in a factory setting that may have strict accuracy requirements for which violation could result in harm to workers and/or factory operations. Embodiments also facilitate coexistence between E-CID positioning procedures and DL propagation delay compensation procedures needing or using TA measurements for the same UE(s).

Some embodiments provide techniques for a CU to obtain (and a DU to provide) NR timing advance (TADV) measurements in scenarios when there are no pending E-CID positioning procedures related to the same measurements. For example, these techniques can be embodied as a new F1 RTT PD compensation (PDC) measurement procedure.

In these embodiments, the CU can send a request message to the DU for NR TADV measurement for the purpose of PD compensation. In some embodiments, the request can include a periodicity for reporting the requested measurements. If such information is present, this can indicate that the request is for an “on demand” or “one-time” report.

In some embodiments, when the CU has requested (and the DU is providing) periodic reporting of NR TADV measurements, the CU can send the DU a second message indicating that the reporting should be stopped or aborted. In some variants, the second message can indicate specific cells for which reporting should aborted; the absence of this information can indicate that reporting should be aborted for all cells associated with the original request.

Table 6 below provides an exemplary structure of a message sent by a CU (e.g., via F1AP) to request NR timing advance from a DU. The request includes a RAN UE Measurement ID field that can distinguish between parallel procedures on-going over F1 for the same measurement, an indication of the measurement item to report, and a desired periodicity of the reporting (e.g., in ms).

TABLE 6

| | | | Semantics |
|---|---|---|---|
| IE/Group Name | Pres. | IE type/ref. | description |
| Message Type | M | 9.3.1.1 | |
| gNB-CU UE F1AP ID | M | 9.3.1.4 | |
| gNB-DU UE F1AP ID | M | 9.3.1.5 | |
| RAN UE Measurement ID | M | INTEGER (1 . . . 256, . . .) | |
| Reporting periodicity | O | ENUMERATED (120 ms, . . . , | Desired Periodicity of |
| | | 40960 ms) | the reporting |
| Measurement Item CHOICE | 1 | | |
| > NR timing advance | M | ENUMERATED (true, . . .) | |

In some embodiments, which cell(s), cell group(s), or TAG(s) to measure can also be indicated explicitly in the CU's FLAP request message (e.g., by a field or fields added to Table 6 above). In other embodiments, upon receiving the DU's response with the requested value of the NR timing advance, the CU implicitly understands that the DU performed TA measurement on the UE's PCell or on the primary TAG in the UE's Master Cell Group (MCG).

Other embodiments include corresponding operations performed by the DU. Upon receiving the request from the CU (e.g., as in Table 6 above), the DU transmits a PDCCH order in the UE's PCell. PDCCH order is a procedure to bring an UL out-of-sync UE back in-sync in case there is DL data available for the UE. The PDCCH order is transmitted by gNB in DCI format 1_0 scrambled by the cell radio network temporary identifier (C-RNTI), having a frequency domain resource assignment (FDRA) field of all ones, and indicating a random access preamble index. Upon receiving this DCI, the UE initiates a random access procedure with the indicated preamble for contention-free random access (CFRA). A result of the CFRA is that the gNB obtains an up-to-date TA measurement for the UE.

In some variants, the DU transmits the PDCCH order if the request from the CU indicates that the report is “on demand” but refrains from refrains from transmitting the PDCCH order if the request from the CU indicates that the report is “periodic” and certain conditions are met. For example, the DU can refrain from transmitting the PDCCH order when the DU determines or estimates that the UE's UL TA value has not changed significantly since the last reported measurement. In such case, a UE's random access to generate a new measurement would be a waste of resources and cause unnecessary UE energy consumption. The DU can make this determination based one or more of the following conditions since the last DU report of NR TADV to the CU:
the DU has not transmitted any TA command MAC CEs related to the PTAG of the UE's MCG (i.e., TAG that contains the UE's PCell); and
the timeAlignmentTimer associated with the PTAG has not been expired.

Table 7 below provides an exemplary structure of a DU response (e.g., via F1AP) to a CU's request for NR timing advance. The response includes a RAN UE Measurement ID field with the same value as in the RAN UE Measurement ID field of the request. The response also includes the requested measurement (NR TADV) and an indication of the uncertainty of this measurement.

TABLE 7

| | | | Semantics |
|---|---|---|---|
| IE/Group Name | Pres. | IE type/ref. | description |
| Message Type | M | 9.3.1.1 | |
| gNB-CU UE F1AP ID | M | 9.3.1.4 | |
| gNB-DU UE F1AP ID | M | 9.3.1.5 | |
| RAN UE Measurement ID | M | INTEGER (1 . . . 256, . . .) | |
| NR TADV | M | INTEGER (0 . . . 7690) | As defined in TS 38.215 |
| Uncertainty range | O | INTEGER (0 . . . 3845) | Uncertainty range of the |
| | | | NR TADV |

Various other embodiments provide techniques for coexistence between E-CID positioning and PD compensation with respect to NR timing advance (TADV) measurements. In some embodiments, a CU can reuse an NR TADV for a particular UE obtained via E-CID related signaling for purposes of PD compensation (e.g., provided that the measured timing advance is for the UE's PCell). In some embodiments, the CU can reuse such information until expiration of a timer that the CU started upon obtaining the information. In other words, the NR TADV measured for either PD compensation or NR E-CID (e.g., if measured on the PCell) is valid while the timer is running but is no longer valid after the timer expires. In some variants, the CU can reuse such information only on the UE's PCell or on another specific group of cells.

In some embodiments, when the CU receives a request from another network node (e.g., LMF) to measure NR TADV for E-CID positioning and the CU has already requested the DU to provide the same measurement for RTT PD compensation, the CU can request the DU to revoke the previously requested measurement in relation to PD compensation. Table 8 below shows an adaptation of the E-CID MEASUREMENT INITIATION REQUEST message shown in Table 3 above according to these embodiments. In particular, the message in Table 8 includes an RTT-PDC Measurement Revoked field that includes a sub-field containing the same RAN measurement ID used to request the measurement to be revoked and a sub-field containing an enumerated indication of whether the measurement is being revoked by the CU.

TABLE 8

| | | | Semantics |
|---|---|---|---|
| IE/Group Name | Range | IE type/ref. | description |
| Message Type | | 9.3.1.1 | |
| gNB-CU UE F1AP ID | | 9.3.1.4 | |
| gNB-DU UE F1AP ID | | 9.3.1.5 | |
| LMF UE Measurement ID | | INTEGER (1 . . . 256, . . .) | |
| RAN UE Measurement ID | | INTEGER (1 . . . 256, . . .) | |
| E-CID Report | | ENUMERATED | |
| Characteristics | | (OnDemand, Periodic, | |
| | | . . .) | |
| E-CID Measurement | | ENUMERATED | |
| Periodicity | | (120 ms, 240 ms, 480 ms, | |
| | | 640 ms, 1024 ms, | |
| | | 2048 ms, 5120 ms, | |
| | | 10240 ms, 1 min, 6 min, | |
| | | 12 min, 30 min, . . . , | |
| | | 20480 ms, 40960 ms) | |
| E-CID Measurement | 1 . . . | | |
| Quantities | <maxnoofMeasE-CID> | | |
| >E-CID Measurement | | ENUMERATED | If “Default” is the only |
| Quantities Item | | (Default, NR Angle of | requested measurement |
| | | Arrival, . . . , NR Timing | quantity, it indicates that |
| | | Advance) | the Measured Results List |
| | | | IE need not be included in |
| | | | response or reporting |
| | | | messages. |
| RTT-PDC Measurement | 1 . . . | | |
| Revoked | <maxnoofMeasRTT-PDC> | | |
| >RAN UE RTT PDC | | INTEGER (1 . . . 16, . . .) | |
| Measurement ID | | | |
| >RAN UE RTT PDC | | ENUMERATED (yes, | Value “yes” indicate that |
| Measurement Revoked | | no . . .) | gNB-DU will revoke the |
| | | | indicated measurement. |

Other embodiments include corresponding operations performed by the DU. In some embodiments, a DU can refrain from transmitting the PDCCH order when the DU determines or estimates that the UE's UL TA value has not changed significantly since the last reported measurement. In such case, a UE's random access to generate a new measurement would be a waste of resources and cause unnecessary UE energy consumption. The last reported measurements can be from the E-CID framework or from a previous triggering for PD compensation. In a similar manner as described above, the DU can make this determination based one or more of the following conditions since the last DU report of NR TADV to the CU:
the DU has not transmitted any TA command MAC CEs related to the PTAG of the UE's MCG (i.e., TAG that contains the UE's PCell); and
the timeAlignmentTimer associated with the PTAG has not been expired.

In some embodiments, upon receiving a request from the CU for a TA measurement for PD compensation, the DU can refrain from transmitting a PDCCH order when there is an ongoing random access (e.g., due to another PDCCH order) related to E-CID positioning. In other embodiments, upon receiving a request from the CU for a TA measurement for E-CID positioning, the DU can refrain from transmitting a PDCCH order when there is an ongoing random access related to PD compensation (e.g., due to another PDCCH order). In both scenarios, upon finishing the measurements, the same measurement results can be used as DU responses to both procedures.

In some embodiments, the DU may revoke the previous request for NR TA sent in the new procedure for RTT PDC Measurement procedure, if it receives a revoke indication from the CU in another subsequent message referring to the RTT PDC Measurement ID.

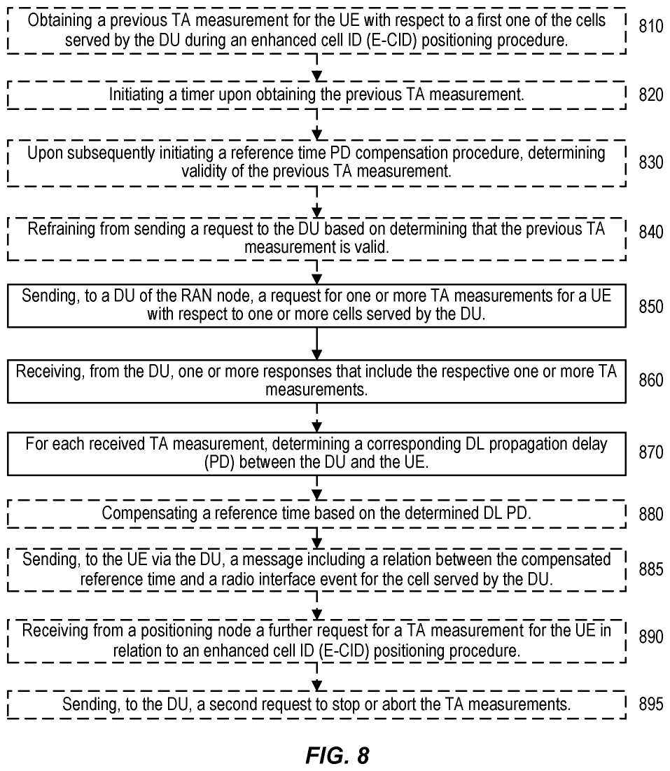

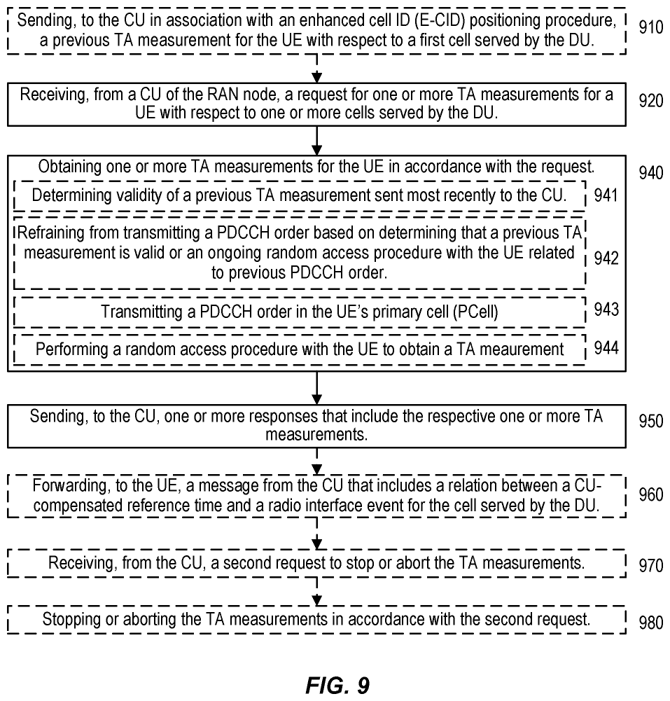

These embodiments described above can be further illustrated with reference to FIGS. 8-9, which depict exemplary methods (e.g., procedures) performed by a CU and a DU, respectively. Put differently, various features of the operations described below correspond to various embodiments described above. Although the exemplary methods are illustrated in FIGS. 8-9 by specific blocks in a particular order, the operations corresponding to the blocks can be performed in different orders than shown and can be combined and/or divided into blocks having different functionality than shown. Furthermore, the exemplary methods shown in FIGS. 8-9 can be complementary to each other, such that they can be used cooperatively to provide various benefits, advantages, and/or solutions to problems, including those described herein. Optional blocks and/or operations are indicated by dashed lines.

In particular, FIG. 8 illustrates an exemplary method (e.g., procedure) for a centralized unit (CU) of a radio access network (RAN) node, according to various embodiments of the present disclosure. For example, the exemplary method shown in FIG. 8 can be implemented by a CU (e.g., gNB-CU) such as described elsewhere herein.

The exemplary method can include the operations of block 850, in which the CU can send, to a DU of the RAN node, a request for one or more TA measurements for a UE with respect to one or more cells served by the DU. The exemplary method can also include the operations of block 860, in which the CU can receive, from the DU, one or more responses that include the respective one or more TA measurements. The exemplary method can also include the operations of block 870, in which for each received TA measurement, the CU can determine a corresponding DL propagation delay (PD) between the DU and the UE.

In some embodiments, the request indicates whether on-demand or periodic reporting of TA measurements is requested. In some of these embodiments, when the request indicates on-demand reporting, a single response including a single TA measurement is received from the DU. In other of these embodiments, when the request indicates periodic reporting, the request also includes a requested periodicity of the TA measurement. In such case, a plurality of responses including a respective plurality of periodic TA measurements are received from the DU spaced in time according to the requested periodicity.

In some embodiments, each response also includes an uncertainty associated with the TA measurement included in the response.

In some embodiments, the request includes an identifier associated with the requested TA measurements and each response includes the identifier. In some of these embodiments, the exemplary method can also include the operations of block 895, where the CU can send, to the DU, a second request to stop or abort the TA measurements. The second request includes the identifier. In some variants, the exemplary method can also include the operations of block 890, where after sending the request, the CU can receive from a positioning node a further request for a TA measurement for the UE in relation to an enhanced cell ID (E-CID) positioning procedure. In such case, the second request is sent to the DU in response to the further request from the positioning node.

In some embodiments, the request also includes identifiers associated with the one or more cells for which TA measurements are requested and are provided in the respective responses. In other embodiments, the request does not include identifiers associated with the one or more cells and the respective responses include TA measurements on one of the following: the UE's primary cell (PCell), or the primary timing advance group (TAG) in the UE's master cell group (MCG).

In some embodiments, the exemplary method can also include the operations of blocks 810 and 830, where the CU can obtain a previous TA measurement for the UE with respect to a first one of the cells served by the DU during an E-CID positioning procedure and upon subsequently initiating a reference time PD compensation procedure, determine validity of the previous TA measurement. The request is sent (e.g., in block 850) based on determining in block 830 that the previous TA measurement is not valid.

In some of these embodiments, the exemplary method can also include the operations of block 840, where the CU can refrain from sending the request based on determining in block 830 that the previous TA measurement is valid. In such case, determining the DL PD (e.g., in block 870) is based on the previous TA measurement. Put differently, the operations of blocks 840 and 850 can be mutually exclusive.

In some of these embodiments, the exemplary method can also include the operations of block 820, where the CU can initiate a timer upon obtaining the previous TA measurement (e.g., in block 810). In such case, determining validity of the previous TA measurement (e.g., in block 830) is based on whether the timer has expired at the time of initiating the reference time PD compensation procedure.

In some embodiments, the requested TA measurements are for T_{ADV}=T_{gNB-RX}−T_{gNB-TX}, where:
T_{gNB-RX} is an uplink receive timing, at a TRP associated with the DU, of subframe i containing a PRACH transmitted by the UE; and
T_{gNB-TX} is a downlink transmit timing at the TRP of subframe j that is closest in time to subframe i received from the UE.

In some embodiments, the exemplary method can also include the operations of blocks 880-885, where the CU can compensate a reference time based on the determined DL PD and send, to the UE via the DU, a message including a relation between the compensated reference time and a radio interface event for the cell served by the DU. In some of these embodiments, the radio interface event is a boundary of a system frame number (SFN), the reference time is a system clock time for the SFN boundary at the DU transmitter, and the compensated reference time is the system clock time for the SFN boundary at the UE receiver.

In addition, FIG. 9 illustrates an exemplary method (e.g., procedure) for a DU of a RAN node, according to various embodiments of the present disclosure. For example, the exemplary method shown in FIG. 9 can be implemented by a DU (e.g., gNB-DU) such as described elsewhere herein.

The exemplary method can include the operations of block 920, where the DU can receive, from a CU of the RAN node, a request for one or more TA measurements for a UE with respect to one or more cells served by the DU. The exemplary method can also include the operations of block 940, in which the DU can obtain one or more TA measurements for the UE in accordance with the request. The exemplary method can also include the operations of block 950, in which the DU can send, to the CU, one or more responses that include the respective one or more TA measurements.

In some embodiments, the request indicates whether on-demand or periodic reporting of TA measurements is requested. In some of these embodiments, when the request indicates on-demand reporting, a single response including a single TA measurement is received from the DU. In other of these embodiments, when the request indicates periodic reporting, the request also includes a requested periodicity of the TA measurement. In such case, a plurality of responses including a respective plurality of periodic TA measurements are received from the DU spaced in time according to the requested periodicity.

In some embodiments, each response also includes an uncertainty associated with the TA measurement included in the response.

In some embodiments, the request includes an identifier associated with the requested TA measurements and each response includes the identifier. In some of these embodiments, the exemplary method can also include the operations of block 970, where the DU can receive from the CU a second request to stop or abort the TA measurements. The second request includes the identifier. In block 980, the DU can stop or abort the TA measurements in accordance with the second request. In some of these embodiments, the second request is received from the CU based on a further request from a positioning node for a TA measurement for the UE in relation to an E-CID positioning procedure.

In some embodiments, the request also includes identifiers associated with the one or more cells for which TA measurements are requested and are provided in the respective responses. In other embodiments, the request does not include identifiers associated with the one or more cells and the respective responses include TA measurements on one of the following: the UE's primary cell (PCell), or the primary timing advance group (TAG) in the UE's master cell group (MCG).

In some embodiments, the exemplary method can also include the operations of block 910, where the DU can send, to the CU in association with an E-CID positioning procedure, a previous TA measurement for the UE with respect to a first one of the cells served by the DU. In such case, the request is received (e.g., in block 920) after the previous TA measurement becomes invalid (e.g., as determined by the CU in the manner described above).

In some embodiments, obtaining the one or more TA measurements for the UE in block 940 includes the operations of sub-blocks 943-944, where the DU can transmit a PDCCH order in the UE's PCell and responsive to the PDCCH order, perform a random access procedure (e.g., CFRA) with the UE responsive to obtain a TA measurement.

In some of these embodiments, the PDCCH order is transmitted and the RA procedure is performed when the request indicates that on-demand reporting of TA measurements is requested. In other of these embodiments, when the request indicates that periodic reporting of TA measurements is requested, obtaining the one or more TA measurements for the UE in block 940 includes the operations of sub-block 941, where for each of the requested TA measurements, the DU can determine validity of a previous TA measurement sent most recently to the CU. In such case, the PDCCH order is transmitted (e.g., in sub-block 943) and the RA procedure performed (e.g., in sub-block 944) based on determining that the previous TA measurement is invalid.

In some variants of these embodiments, obtaining the one or more TA measurements for the UE in block 940 includes the operations of sub-block 942, where for each of the requested TA measurements, the DU can refrain from transmitting the PDCCH order and performing the RA procedure based on one or more of the following: determining that the previous TA measurement is valid (e.g., in block 941); and an ongoing RA procedure with the UE related to a previous PDCCH order.

In some of these embodiments, the previous TA measurement is determined to be valid (e.g., in sub-block 941) based on one or more of the following:
since sending the previous TA measurement to the CU (e.g., in block 910), the DU has not transmitted any TA commands related to a primary TA group (PTAG) that includes the UE's primary cell (PCell); and
a timeAlignmentTimer associated with the PTAG has not been expired.

In some embodiments, each obtained TA measurement is for T_{ADV}=T_{gNB-RX}−T_{gNB-TX}, where:
T_{gNB-RX} is an uplink receive timing, at a TRP associated with the DU, of subframe i containing a PRACH transmitted by the UE; and
T_{gNB-TX} is a downlink transmit timing at the TRP of subframe j that is closest in time to subframe i received from the UE.

In some embodiments, the exemplary method can also include the operations of block 960, where the DU can forward, to the UE, a message from the CU that includes a relation between a CU-compensated reference time and a radio interface event for the cell served by the DU. In some of these embodiments, the radio interface event is a boundary of a system frame number (SFN), the reference time is compensated by the CU based on one or more of the TA measurements sent by the DU, and the compensated reference time is the system clock time for the SFN boundary at the UE receiver.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

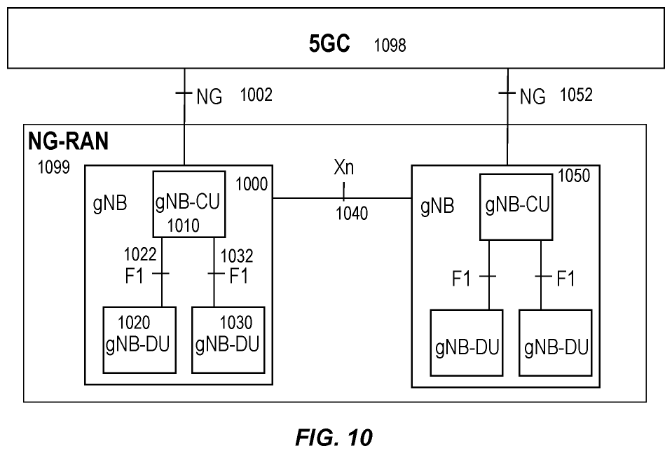

FIG. 10 illustrates an exemplary high-level view of the 5G network architecture, consisting of a Next Generation RAN (NG-RAN) 1099 and a 5G Core (5GC) 1098. NG-RAN 1099 can include a set of gNodeB's (gNBs) connected to the 5GC via one or more NG interfaces, such as gNBs 1000, 1050 connected via interfaces 1002, 1052, respectively. In addition, the gNBs can be connected to each other via one or more Xn interfaces, such as Xn interface 1040 between gNBs 1000 and 1050. With respect the NR interface to UEs, each of the gNBs can support frequency division duplexing (FDD), time division duplexing (TDD), or a combination thereof.

NG-RAN 199 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

The NG RAN logical nodes shown in FIG. 10 include a central (or centralized) unit (CU or gNB-CU) and one or more distributed (or decentralized) units (DU or gNB-DU). For example, gNB 1000 includes gNB-CU 1010 and gNB-DUs 1020 and 1030. CUs (e.g., gNB-CU 1010) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUS and DUs can include various circuitry needed to perform their respective functions, including processing circuitry, transceiver circuitry (e.g., for communication), and power supply circuitry.

A gNB-CU connects to gNB-DUs over respective F1 logical interfaces, such as interfaces 1022 and 1032 shown in FIG. 10. The gNB-CU and connected gNB-DUs are only visible to other gNBs and the 5GC as a gNB. In other words, F1 interface is not visible beyond gNB-CU.

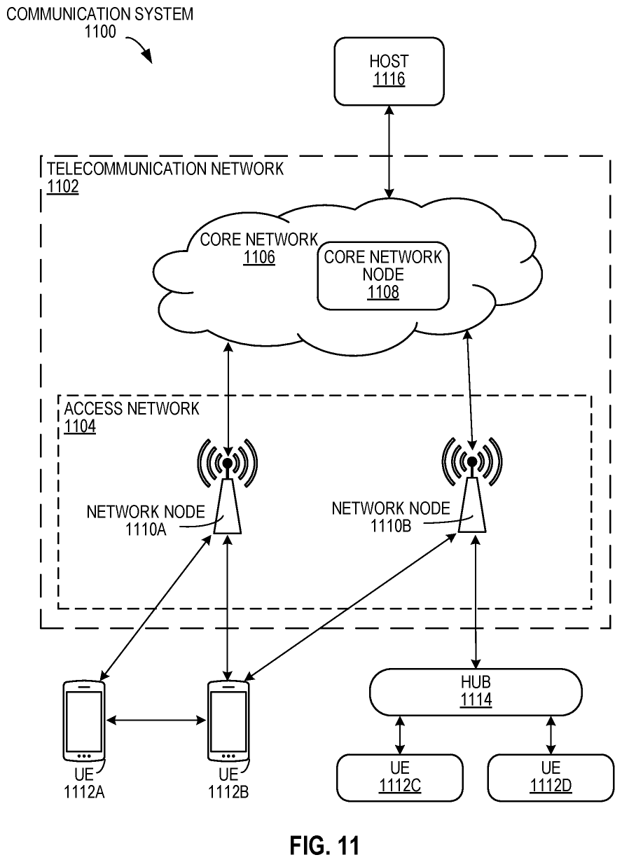

FIG. 11 shows an example of a communication system 1100 in accordance with some embodiments. In this example, communication system 1100 includes a telecommunication network 1102 that includes an access network 1104, such as a RAN, and a core network 1106, which includes one or more core network nodes 1108. Access network 1104 includes one or more access network nodes, such as network nodes 1110a-b (one or more of which may be generally referred to as network nodes 1110), or any other similar 3GPP access node or non-3GPP access point. The network nodes 1110 facilitate direct or indirect connection of UEs, such as by connecting UEs 1112a-d (one or more of which may be generally referred to as UEs 1112) to core network 1106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1100 may include any number of wired or wireless networks, network nodes, UEs, and/or any other components or systems that may facilitate or participate in the communication of data and/or signals whether via wired or wireless connections. Communication system 1100 may include and/or interface with any type of communication, telecommunication, data, cellular, radio network, and/or other similar type of system.

UEs 1112 may be any of a wide variety of communication devices, including wireless devices arranged, configured, and/or operable to communicate wirelessly with the network nodes 1110 and other communication devices. Similarly, the network nodes 1110 are arranged, capable, configured, and/or operable to communicate directly or indirectly with UEs 1112 and/or with other network nodes or equipment in telecommunication network 1102 to enable and/or provide network access, such as wireless network access, and/or to perform other functions, such as administration in telecommunication network 1102.

In the depicted example, core network 1106 connects the network nodes 1110 to one or more hosts, such as host 1116. These connections may be direct or indirect via one or more intermediary networks or devices. In other examples, network nodes may be directly coupled to hosts. Core network 1106 includes one more core network nodes (e.g., core network node 1108) that are structured with hardware and software components. Features of these components may be substantially similar to those described with respect to the UEs, network nodes, and/or hosts, such that the descriptions thereof are generally applicable to the corresponding components of core network node 1108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1116 may be under the ownership or control of a service provider other than an operator or provider of access network 1104 and/or telecommunication network 1102 and may be operated by the service provider or on behalf of the service provider. Host 1116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1100 of FIG. 11 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1102 is a cellular network that implements 3GPP standardized features. Accordingly, telecommunication network 1102 may support network slicing to provide different logical networks to different devices that are connected to telecommunication network 1102. For example, telecommunication network 1102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1112 are configured to transmit and/or receive information without direct human interaction. For instance, a UE may be designed to transmit information to access network 1104 on a predetermined schedule, when triggered by an internal or external event, or in response to requests from access network 1104. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1114 communicates with access network 1104 to facilitate indirect communication between one or more UEs (e.g., UE 1112c and/or 1112d) and network nodes (e.g., network node 1110b). In some examples, hub 1114 may be a controller, router, content source and analytics, or any of the other communication devices described herein regarding UEs. For example, hub 1114 may be a broadband router enabling access to core network 1106 for the UEs. As another example, hub 1114 may be a controller that sends commands or instructions to one or more actuators in the UEs. Commands or instructions may be received from the UEs, network nodes 1110, or by executable code, script, process, or other instructions in hub 1114. As another example, hub 1114 may be a data collector that acts as temporary storage for UE data and, in some embodiments, may perform analysis or other processing of the data. As another example, hub 1114 may be a content source. For example, for a UE that is a VR headset, display, loudspeaker or other media delivery device, hub 1114 may retrieve VR assets, video, audio, or other media or data related to sensory information via a network node, which hub 1114 then provides to the UE either directly, after performing local processing, and/or after adding additional local content. In still another example, hub 1114 acts as a proxy server or orchestrator for the UEs, in particular in if one or more of the UEs are low energy IoT devices.

Hub 1114 may have a constant/persistent or intermittent connection to network node 1110b. Hub 1114 may also allow for a different communication scheme and/or schedule between hub 1114 and UEs (e.g., UE 1112c and/or 1112d), and between hub 1114 and core network 1106. In other examples, hub 1114 is connected to core network 1106 and/or one or more UEs via a wired connection. Moreover, hub 1114 may be configured to connect to an M2M service provider over access network 1104 and/or to another UE over a direct connection. In some scenarios, UEs may establish a wireless connection with the network nodes 1110 while still connected via hub 1114 via a wired or wireless connection. In some embodiments, hub 1114 may be a dedicated hub—that is, a hub whose primary function is to route communications to/from the UEs from/to network node 1110b. In other embodiments, hub 1114 may be a non-dedicated hub—that is, a device which is operable to route communications between the UEs and network node 1110b, but which is additionally capable of operating as a communication start and/or end point for certain data channels.

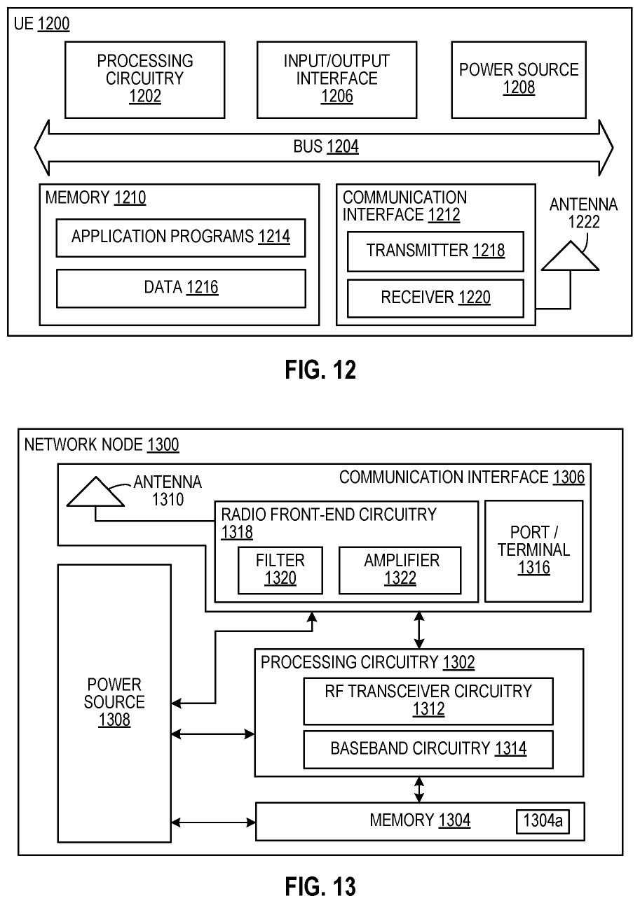

FIG. 12 shows a UE 1200 in accordance with some embodiments. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1200 includes processing circuitry 1202 that is operatively coupled via a bus 1204 to an input/output interface 1206, a power source 1208, a memory 1210, a communication interface 1212, and/or any other component, or any combination thereof. Certain UEs may utilize all or a subset of the components shown in FIG. 12. The level of integration between the components may vary from one UE to another UE. Further, certain UEs may contain multiple instances of a component, such as multiple processors, memories, transceivers, transmitters, receivers, etc.

Processing circuitry 1202 is configured to process instructions and data and may be configured to implement any sequential state machine operative to execute instructions stored as machine-readable computer programs in memory 1210. Processing circuitry 1202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1202 may include multiple central processing units (CPUs).

In the example, the input/output interface 1206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into UE 1200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1208 is structured as a battery or battery pack. Other types of power sources, such as an external power source (e.g., an electricity outlet), photovoltaic device, or power cell, may be used. Power source 1208 may further include power circuitry for delivering power from power source 1208 itself, and/or an external power source, to the various parts of UE 1200 via input circuitry or an interface such as an electrical power cable. Delivering power may be, for example, for charging of power source 1208. Power circuitry may perform any formatting, converting, or other modification to the power from power source 1208 to make the power suitable for the respective components of UE 1200 to which power is supplied.

Memory 1210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1210 includes one or more application programs 1214, such as an operating system, web browser application, a widget, gadget engine, or other application, and corresponding data 1216. Memory 1210 may store, for use by UE 1200, any of a variety of various operating systems or combinations of operating systems.

Memory 1210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1210 may allow UE 1200 to access instructions, application programs and the like, stored on transitory or non-transitory memory media, to off-load data, or to upload data. An article of manufacture, such as one utilizing a communication system may be tangibly embodied as or in memory 1210, which may be or comprise a device-readable storage medium.

Processing circuitry 1202 may be configured to communicate with an access network or other network using communication interface 1212, which may comprise one or more communication subsystems and may include or be communicatively coupled to an antenna 1222. Communication interface 1212 may include one or more transceivers used to communicate, such as by communicating with one or more remote transceivers of another device capable of wireless communication (e.g., another UE or a network node in an access network). Each transceiver may include a transmitter 1218 and/or a receiver 1220 appropriate to provide network communications (e.g., optical, electrical, frequency allocations, and so forth). Moreover, the transmitter 1218 and receiver 1220 may be coupled to one or more antennas (e.g., antenna 1222) and may share circuit components, software or firmware, or alternatively be implemented separately.

In the illustrated embodiment, communication functions of communication interface 1212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1200 shown in FIG. 12.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 13 shows a network node 1300 in accordance with some embodiments. Examples of network nodes include, but are not limited to, access points (e.g., radio access points) and base stations (e.g., radio base stations, Node Bs, eNBs, gNBs, etc.).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions (collectively denoted computer program product 1304a) capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

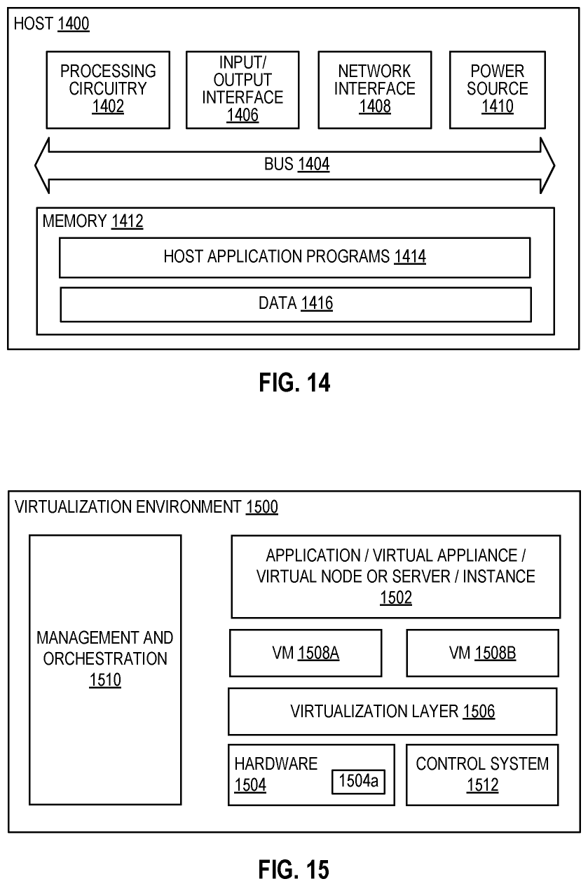

FIG. 14 is a block diagram of a host 1400, which may be an embodiment of the host 1116 of FIG. 11, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

The host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416, which may include user data, e.g., data generated by a UE for the host 1400 or data generated by the host 1400 for a UE. Embodiments of the host 1400 may utilize only a subset or all of the components shown. The host application programs 1414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1414 may also provide for user authentication and licensing checks and may periodically report health, routes, and content availability to a central node, such as a device in or on the edge of a core network. Accordingly, the host 1400 may select and/or indicate a different host for over-the-top services for a UE. The host application programs 1414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 15 is a block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1502 (which may alternatively be called software instances, virtual appliances, network functions, virtual nodes, virtual network functions, etc.) are run in the virtualization environment 1500 to implement some of the features, functions, and/or benefits of some of the embodiments disclosed herein.

Hardware 1504 includes processing circuitry, memory that stores software and/or instructions (collectively denoted computer program product 1504a) executable by hardware processing circuitry, and/or other hardware devices as described herein, such as a network interface, input/output interface, and so forth. Software may be executed by the processing circuitry to instantiate one or more virtualization layers 1506 (also referred to as hypervisors or virtual machine monitors (VMMs)), provide VMs 1508a and 1508b (one or more of which may be generally referred to as VMs 1508), and/or perform any of the functions, features and/or benefits described in relation with some embodiments described herein. The virtualization layer 1506 may present a virtual operating platform that appears like networking hardware to the VMs 1508.

The VMs 1508 comprise virtual processing, virtual memory, virtual networking or interface and virtual storage, and may be run by a corresponding virtualization layer 1506. Different embodiments of the instance of a virtual appliance 1502 may be implemented on one or more of VMs 1508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1508 may be a software implementation of a physical machine that runs programs as if they were executing on a physical, non-virtualized machine. Each of the VMs 1508, and that part of hardware 1504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1508 on top of the hardware 1504 and corresponds to the application 1502.

Hardware 1504 may be implemented in a standalone network node with generic or specific components. Hardware 1504 may implement some functions via virtualization. Alternatively, hardware 1504 may be part of a larger cluster of hardware (e.g., such as in a data center or CPE) where many hardware nodes work together and are managed via management and orchestration 1510, which, among others, oversees lifecycle management of applications 1502. In some embodiments, hardware 1504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1512 which may alternatively be used for communication between hardware nodes and radio units.

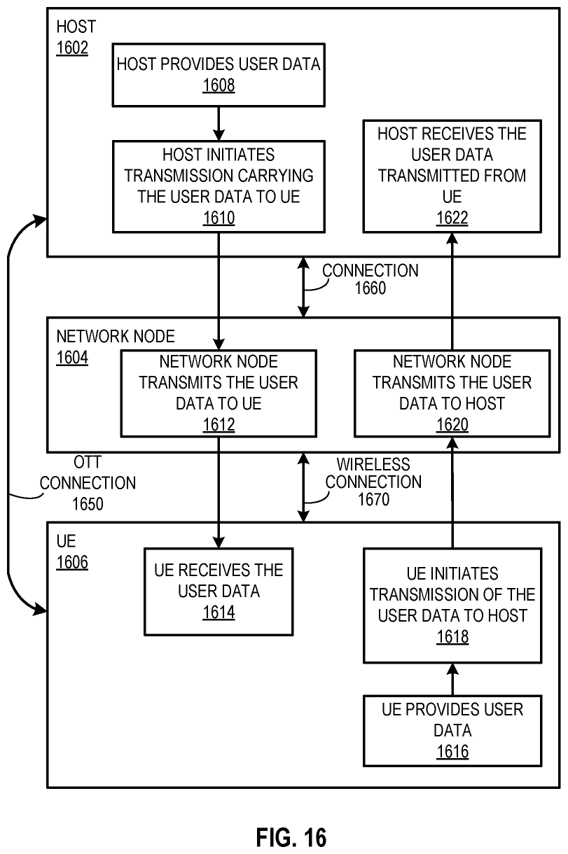

FIG. 16 shows a communication diagram of a host 1602 communicating via a network node 1604 with a UE 1606 over a partially wireless connection in accordance with some embodiments. Example implementations, in accordance with various embodiments, of the UE (such as a UE 1112a of FIG. 11 and/or UE 1200 of FIG. 12), network node (such as network node 1110a of FIG. 11 and/or network node 1300 of FIG. 13), and host (such as host 1116 of FIG. 11 and/or host 1400 of FIG. 14) discussed in the preceding paragraphs will now be described with reference to FIG. 16.

Like host 1400, embodiments of host 1602 include hardware, such as a communication interface, processing circuitry, and memory. The host 1602 also includes software, which is stored in or accessible by the host 1602 and executable by the processing circuitry. The software includes a host application that may be operable to provide a service to a remote user, such as the UE 1606 connecting via an over-the-top (OTT) connection 1650 extending between the UE 1606 and host 1602. In providing the service to the remote user, a host application may provide user data which is transmitted using the OTT connection 1650.

The network node 1604 includes hardware enabling it to communicate with the host 1602 and UE 1606. The connection 1660 may be direct or pass through a core network (like core network 1106 of FIG. 11) and/or one or more other intermediate networks, such as one or more public, private, or hosted networks. For example, an intermediate network may be a backbone network or the Internet.

The UE 1606 includes hardware and software, which is stored in or accessible by UE 1606 and executable by the UE's processing circuitry. The software includes a client application, such as a web browser or operator-specific “app” that may be operable to provide a service to a human or non-human user via UE 1606 with the support of the host 1602. In the host 1602, an executing host application may communicate with the executing client application via the OTT connection 1650 terminating at the UE 1606 and host 1602. In providing the service to the user, the UE's client application may receive request data from the host's host application and provide user data in response to the request data. The OTT connection 1650 may transfer both the request data and the user data. The UE's client application may interact with the user to generate the user data that it provides to the host application through the OTT connection 1650.

The OTT connection 1650 may extend via a connection 1660 between the host 1602 and the network node 1604 and via a wireless connection 1670 between the network node 1604 and the UE 1606 to provide the connection between the host 1602 and the UE 1606. The connection 1660 and wireless connection 1670, over which the OTT connection 1650 may be provided, have been drawn abstractly to illustrate the communication between the host 1602 and the UE 1606 via the network node 1604, without explicit reference to any intermediary devices and the precise routing of messages via these devices.

As an example of transmitting data via the OTT connection 1650, in step 1608, the host 1602 provides user data, which may be performed by executing a host application. In some embodiments, the user data is associated with a particular human user interacting with the UE 1606. In other embodiments, the user data is associated with a UE 1606 that shares data with the host 1602 without explicit human interaction. In step 1610, the host 1602 initiates a transmission carrying the user data towards the UE 1606. The host 1602 may initiate the transmission responsive to a request transmitted by the UE 1606. The request may be caused by human interaction with the UE 1606 or by operation of the client application executing on the UE 1606. The transmission may pass via the network node 1604, in accordance with the teachings of the embodiments described throughout this disclosure. Accordingly, in step 1612, the network node 1604 transmits to the UE 1606 the user data that was carried in the transmission that the host 1602 initiated, in accordance with the teachings of the embodiments described throughout this disclosure. In step 1614, the UE 1606 receives the user data carried in the transmission, which may be performed by a client application executed on the UE 1606 associated with the host application executed by the host 1602.

In some examples, the UE 1606 executes a client application which provides user data to the host 1602. The user data may be provided in reaction or response to the data received from the host 1602. Accordingly, in step 1616, the UE 1606 may provide user data, which may be performed by executing the client application. In providing the user data, the client application may further consider user input received from the user via an input/output interface of the UE 1606. Regardless of the specific manner in which the user data was provided, the UE 1606 initiates, in step 1618, transmission of the user data towards the host 1602 via the network node 1604. In step 1620, in accordance with the teachings of the embodiments described throughout this disclosure, the network node 1604 receives user data from the UE 1606 and initiates transmission of the received user data towards the host 1602. In step 1622, the host 1602 receives the user data carried in the transmission initiated by the UE 1606.

One or more of the various embodiments improve the performance of OTT services provided to the UE 1606 using the OTT connection 1650, in which the wireless connection 1670 forms the last segment. More precisely, embodiments can enable CUs to acquire from DUs up-to-date TA measurements for UEs in a cell served by the DU, thereby facilitating accurate compensation for DL propagation delay in reference time information provided by the CU to these UEs. This can improve accuracy and/or reduce uncertainty of timing relationships and thereby facilitate compliance with end-to-end accuracy requirements for delivery of TSN time information to remotely located end stations connected to a 5G network. This can be particularly beneficial for IIOT devices in a factory setting that may have strict accuracy requirements for which violation could result in harm to workers and/or factory operations. OTT data services that have highly-accurate timing requirements will benefit from the increased timing accuracy provided by various embodiments of the present disclosure.

In an example scenario, factory status information may be collected and analyzed by the host 1602. As another example, the host 1602 may process audio and video data which may have been retrieved from a UE for use in creating maps. As another example, the host 1602 may collect and analyze real-time data to assist in controlling vehicle congestion (e.g., controlling traffic lights). As another example, the host 1602 may store surveillance video uploaded by a UE. As another example, the host 1602 may store or control access to media content such as video, audio, VR or AR which it can broadcast, multicast or unicast to UEs. As other examples, the host 1602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring the OTT connection 1650 between the host 1602 and UE 1606, in response to variations in the measurement results. The measurement procedure and/or the network functionality for reconfiguring the OTT connection may be implemented in software and hardware of the host 1602 and/or UE 1606. In some embodiments, sensors (not shown) may be deployed in or in association with other devices through which the OTT connection 1650 passes; the sensors may participate in the measurement procedure by supplying values of the monitored quantities exemplified above or by supplying values of other physical quantities from which software may compute or estimate the monitored quantities. The reconfiguring of the OTT connection 1650 may include message format, retransmission settings, preferred routing etc.; the reconfiguring need not directly alter the operation of the network node 1604. Such procedures and functionalities may be known and practiced in the art. In certain embodiments, measurements may involve proprietary UE signaling that facilitates measurements of throughput, propagation times, latency, etc. by the host 1602. The measurements may be implemented in that software causes messages (e.g., empty or “dummy” messages) to be transmitted using the OTT connection 1650 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

The techniques and apparatus described herein include, but are not limited to, the following enumerated examples:

A1. A method for a centralized unit (CU) of a radio access network (RAN) node, the method comprising:
sending, to a distributed unit (DU) of the RAN node, a request for one or more timing advance (TA) measurements for a user equipment (UE) with respect to one or more cells served by the DU;
receiving, from the DU, one or more responses that include the respective one or more TA measurements; and
for each received TA measurement, determining a corresponding downlink (DL) propagation delay (PD) between the DU and the UE.
   A2. The method of embodiment A1, further comprising:
compensating a reference time based on the determined DL PD; and
sending, to the UE via the DU, a message including a relation between the compensated reference time and a radio interface event for the cell served by the DU.
   A3. The method of any of embodiments A1-A2, wherein:
the radio interface event is a boundary of a system frame number (SFN); and
the reference time is a system clock time for the SFN boundary at the DU transmitter; and
the compensated reference time is the system clock time for the SFN boundary at the UE receiver.
   A4. The method of any of embodiments A1-A3, wherein:
the request includes a requested periodicity of the TA measurements; and
the one or more responses include a plurality of responses that include a respective plurality of periodic TA measurements spaced in time according to the requested periodicity.
   A5. The method of any of embodiments A1-A4, wherein:
the request includes an identifier associated with the requested TA measurements; and
each response includes the identifier.
   A6. The method of embodiment A5, further comprising sending, to the DU, a second request to stop or abort the TA measurements, wherein the second request includes the identifier.
   A7. The method of embodiment A6, wherein:
the method further comprises, after sending the request, receiving from a positioning node a further request for a TA measurement for the UE in relation to an enhanced cell ID (E-CID) positioning procedure; and
the second request is sent to the DU in response to the further request from the positioning node.
   A8. The method of any of embodiments A1-A7, wherein each response also includes an uncertainty associated with the TA measurement included in the response.
   A9. The method of any of embodiments A1-A8, wherein one of the following applies:
the request also includes identifiers associated with the one or more cells for which TA measurements are requested and are provided in the respective responses; or
the request does not include identifiers associated with the one or more cells and the respective responses include TA measurements on one of the following: the UE's primary cell (PCell), or the primary timing advance group (TAG) in the UE's master cell group (MCG).
   A10. The method of any of embodiments A1-A9, further comprising:
obtaining a previous TA measurement for the UE with respect to a first one of the cells served by the DU during an enhanced cell ID (E-CID) positioning procedure; and
upon subsequently initiating a reference time PD compensation procedure, determining validity of the previous TA measurement,
wherein the request is sent based on determining that the previous TA measurement is not valid.
   A11. The method of embodiment A10, wherein:
the method further comprises refraining from sending the request based on determining that the previous TA measurement is valid; and
the DL PD compensation is determined based on the previous TA measurement.
   A12. The method of any of embodiments A10-A11, further comprising initiating a timer upon obtaining the previous TA measurement, wherein determining validity of the previous TA measurement is based on whether the timer has expired at the time of initiating the reference time PD compensation procedure.
   B1. A method for a distributed unit (DU) of a radio access network (RAN) node, the method comprising:
receiving, from a centralized unit (CU) of the RAN node, a request for one or more timing advance (TA) measurements for a user equipment (UE) with respect to one or more cells served by the DU;
obtaining one or more TA measurements for the UE in accordance with the request; and
sending, to the CU, one or more responses that include the respective one or more TA measurements.
   B2. The method of embodiment B1, further comprising forwarding, to the UE, a message from the CU that includes a relation between a CU-compensated reference time and a radio interface event for the cell served by the DU.
   B3. The method of any of embodiments B1-B2, wherein:
the radio interface event is a boundary of a system frame number (SFN);
the reference time is compensated by the CU based on one or more of the TA measurements sent by the DU; and
the compensated reference time is the system clock time for the SFN boundary at the UE receiver.
   B4. The method of any of embodiments B1-B3, wherein:
the request includes a requested periodicity of the TA measurements; and
the one or more responses include a plurality of responses that include a respective plurality of periodic TA measurements spaced in time according to the requested periodicity.
   B5. The method of any of embodiments B1-B4, wherein:
the request includes an identifier associated with the requested TA measurements; and each response includes the identifier.
   B6. The method of embodiment B5, further comprising:
receiving, from the CU, a second request to stop or abort the TA measurements, wherein the second request includes the identifier; and
stopping or aborting the TA measurements in accordance with the second request.
   B7. The method of embodiment B6, wherein the second request is received from the CU based on a further request from a positioning node for a TA measurement for the UE in relation to an enhanced cell ID (E-CID) positioning procedure.
   B8. The method of any of embodiments B1-B7, wherein each response also includes an uncertainty associated with the TA measurement included in the response.
   B9. The method of any of embodiments B1-B8, wherein one of the following applies:
the request also includes identifiers associated with the one or more cells for which TA measurements are requested and are provided in the respective responses; or
the request does not include identifiers associated with the one or more cells and the respective responses include TA measurements on one of the following: the UE's primary cell (PCell), or the primary timing advance group (TAG) in the UE's master cell group (MCG).
   B10. The method of any of embodiments B1-B9, wherein:
the method further comprises sending, to the CU in association with an enhanced cell ID (E-CID) positioning procedure, a previous TA measurement for the UE with respect to a first one of the cells served by the DU; and
the request is received after the previous TA measurement becomes invalid.
   B11. The method of any of embodiments B1-B10, wherein obtaining one or more TA measurements for the UE in accordance with the request comprises:
transmitting a physical downlink control channel (PDCCH) order in the UE's primary cell (PCell); and
performing a random access procedure with the UE responsive to the PDCCH order,
wherein at least one of the TA measurements is obtained based on the random access procedure.
   B12. The method of embodiment B11, wherein:
the method further comprises, in response to the request, determining validity of a previous TA measurement sent most recently to the CU; and
the PDCCH order is transmitted based on determining that the previous TA measurement is invalid.
   B13. The method of any of embodiments B11-B12, wherein obtaining one or more TA measurements for the UE in accordance with the request further comprises refraining from transmitting the PDCCH order based on one of the following:
determining that the previous TA measurement is valid, or
an ongoing random access procedure with the UE related to a previous PDCCH order.
   B14. The method of any of embodiments B11-B13, wherein the previous TA measurement is determined to be valid based on one or more of the following:
since sending the previous TA measurement to the CU, the DU has not transmitted any TA commands related to a primary TA group (PTAG) that includes the UE's primary cell (PCell); and
a timeAlignmentTimer associated with the PTAG has not been expired.
   C1. A centralized unit (CU) of a radio access network (RAN) node, the CU comprising:
communication interface circuitry configured to communicate with at least one distributed unit (DU) of the RAN node; and
processing circuitry operatively coupled to the communication interface circuitry, whereby the processing circuitry and the communication interface circuitry are configured to perform operations corresponding to any of the methods of embodiments A1-A12.
   C2. A centralized unit (CU) of a radio access network (RAN) node, the CU being configured to perform operations corresponding to any of the methods of embodiments A1-A12.
   C3. A non-transitory, computer-readable medium storing computer-executable instructions that, when executed by processing circuitry of a centralized unit (CU) of a radio access network (RAN) node, configure the CU to perform operations corresponding to any of the methods of embodiments A1-A12.
   C4. A computer program product comprising computer-executable instructions that, when executed by processing circuitry of a centralized unit (CU) of a radio access network (RAN) node, configure the CU to perform operations corresponding to any of the methods of embodiments A1-A12.
   D1. A distributed unit (DU) of a radio access network (RAN) node, the DU comprising:
communication interface circuitry configured to communicate with a centralized unit (CU) of the RAN node; and
processing circuitry operatively coupled to the communication interface circuitry, whereby the processing circuitry and the communication interface circuitry are configured to perform operations corresponding to any of the methods of embodiments B1-B14.
   D2. A distributed unit (DU) of a radio access network (RAN) node, the DU, the DU being configured to perform operations corresponding to any of the methods of embodiments B1-B14.
   D3. A non-transitory, computer-readable medium storing computer-executable instructions that, when executed by processing circuitry of a distributed unit (DU) of a radio access network (RAN) node, configure the DU to perform operations corresponding to any of the methods of embodiments B1-B14.
   D4. A computer program product comprising computer-executable instructions that, when executed by processing circuitry of a distributed unit (DU) of a radio access network (RAN) node, configure the DU to perform operations corresponding to any of the methods of embodiments B1-B14.

1.-45. (canceled)

46. A method for a centralized unit (CU) of a radio access network (RAN) node, the method comprising:
sending, to a distributed unit (DU) of the RAN node, a request for one or more timing advance (TA) measurements for a user equipment (UE) with respect to one or more cells served by the DU;
receiving, from the DU, one or more responses that include the respective one or more TA measurements; and
for each received TA measurement, determining a corresponding downlink (DL) propagation delay (PD) between the DU and the UE.

47. The method of claim 46, wherein the request indicates whether on-demand or periodic reporting of TA measurements is requested.

48. The method of claim 47, wherein:
when the request indicates on-demand reporting, a single response including a single TA measurement is received from the DU; and
when the request indicates periodic reporting, the request also includes a requested periodicity of the TA measurements and a plurality of responses including a respective plurality of periodic TA measurements are received from the DU spaced in time according to the requested periodicity.

49. The method of claim 46, wherein:
the request includes an identifier associated with the requested TA measurements; and
each response includes the identifier.

50. The method of claim 49, further comprising:
after sending the request, receiving from a positioning node a further request for a TA measurement for the UE in relation to an enhanced cell ID (E-CID) positioning procedure; and
in response to the further request from the positioning node, sending to the DU a second request to stop or abort the TA measurements, wherein the second request includes the identifier.

51. The method of claim 46, wherein one of the following applies:
the request also includes identifiers associated with the one or more cells for which TA measurements are requested and are provided in the respective responses; or
the request does not include identifiers associated with the one or more cells and the respective responses include TA measurements on one of the following: the UE's primary cell (PCell); or the primary timing advance group (TAG) in the UE's master cell group (MCG).

52. The method of claim 46, further comprising:
obtaining a previous TA measurement for the UE with respect to a first one of the cells served by the DU during an enhanced cell ID (E-CID) positioning procedure; and
upon subsequently initiating a reference time PD compensation procedure, determining validity of the previous TA measurement,
wherein the request is sent based on determining (830) that the previous TA measurement is not valid.

53. The method of claim 42, further comprising initiating a timer upon obtaining the previous TA measurement, wherein determining validity of the previous TA measurement is based on whether the timer has expired at the time of initiating the reference time PD compensation procedure.

54. The method of claim 46, wherein:
the requested TA measurements are for T_{ADV}=T_{gNB-RX}−T_{gNB-TX};
T_{gNB-RX} is an uplink receive timing, at a transmission reception point, TRP, associated with the DU, of subframe i containing a physical random access channel, PRACH, transmitted by the UE; and
T_{gNB-TX} is a DL transmit timing at the TRP of subframe j that is closest in time to subframe i received from the UE.

55. The method of claim 46, further comprising:
based on the determined DL PD, compensating a reference time for a radio interface event for the cell served by the DU, wherein the radio interface event is a boundary of a system frame number (SFN) and the reference time is a system clock time for the SFN boundary at the DU transmitter; and
sending, to the UE via the DU, a message including a relation between the compensated reference time and the radio interface event, wherein the compensated reference time is the system clock time for the SFN boundary at the UE receiver.

56. A method for a distributed unit (DU) of a radio access network (RAN) node, the method comprising:
receiving, from a centralized unit (CU) of the RAN node, a request for one or more timing advance (TA) measurements for a user equipment (UE) with respect to one or more cells served by the DU;
obtaining one or more TA measurements for the UE in accordance with the request; and
sending, to the CU, one or more responses that include the respective one or more TA measurements.

57. The method of claim 56, wherein the request indicates whether on-demand or periodic reporting of TA measurements is requested.

58. The method of claim 57, wherein:
when the request indicates on-demand reporting, a single response including a single TA measurement is sent to the CU; and
when the request indicates periodic reporting, the request also includes a requested periodicity of the TA measurements and a plurality of responses including a respective plurality of periodic TA measurements are sent to the CU spaced in time according to the requested periodicity.

59. The method of claim 56, wherein:
the request includes an identifier associated with the requested TA measurements; and
each response includes the identifier.

60. The method of claim 59, further comprising:
receiving from the CU a second request to stop or abort the TA measurements, wherein the second request includes the identifier and is based on a further request from a positioning node for a TA measurement for the UE in relation to an enhanced cell ID (E-CID) positioning procedure; and
stopping or aborting the TA measurements in accordance with the second request.

61. The method of claim 56, wherein one of the following applies:
the request also includes identifiers associated with the one or more cells for which TA measurements are requested and are provided in the respective responses; or
the request does not include identifiers associated with the one or more cells and the respective responses include TA measurements on one of the following: the UE's primary cell, PCell; or the primary timing advance group, TAG, in the UE's master cell group, MCG.

62. The method of claim 56, wherein:
the method further comprises sending, to the CU in association with an enhanced cell ID (E-CID) positioning procedure, a previous TA measurement for the UE with respect to a first one of the cells served by the DU; and
the request is received after the previous TA measurement becomes invalid.

63. The method of claim 56, wherein obtaining one or more TA measurements for the UE in accordance with the request comprises:
transmitting a physical downlink control channel (PDCCH) order in the UE's primary cell (PCell); and
responsive to the PDCCH order, performing a random access (RA) procedure with the UE to obtain a TA measurement.

64. The method of claim 63, wherein the PDCCH order is transmitted and the RA procedure is performed when the request indicates that on-demand reporting of TA measurements is requested.

65. The method of claim 63, wherein when the request indicates that periodic reporting of TA measurements is requested:
obtaining the one or more TA measurements for the UE in accordance with the request further comprises, for each of the requested TA measurements, determining validity of a previous TA measurement sent most recently to the CU; and
the PDCCH order is transmitted and the RA procedure is performed based on determining that the previous TA measurement is invalid.

66. The method of claim 65, wherein obtaining one or more TA measurements for the UE in accordance with the request further comprises, for each of the requested TA measurements, refraining from transmitting the PDCCH order and performing the RA procedure based on one or more of the following:
determining that the previous TA measurement is valid; and
an ongoing RA procedure with the UE related to a previous PDCCH order.

67. The method of claim 56, wherein:
each obtained TA measurement is for T_{ADV}=T_{gNB-RX}−T_{gNB-TX};
T_{gNB-RX} is an uplink receive timing, at a transmission reception point, TRP, associated with the DU, of subframe i containing a physical random access channel, PRACH, transmitted by the UE; and
T_{gNB-TX} is a downlink transmit timing at the TRP of subframe j that is closest in time to subframe i received from the UE.

68. The method of claim 56, further comprising forwarding, to the UE, a message from the CU that includes a relation between a CU-compensated reference time and a radio interface event for the cell served by the DU, wherein:
the radio interface event is a boundary of a system frame number (SFN);
the reference time is compensated by the CU based on one or more of the TA measurements sent by the DU; and
the compensated reference time is the system clock time for the SFN boundary at the UE receiver.

69. A centralized unit (CU) of a radio access network (RAN) node, the CU comprising:
communication interface circuitry configured to communicate with at least one distributed unit (DU) of the RAN node; and
processing circuitry operatively coupled to the communication interface circuitry, wherein the processing circuitry and the communication interface circuitry are configured to:
send, to a DU, a request for one or more timing advance (TA) measurements for a user equipment (UE) with respect to one or more cells served by the DU;
receive, from the DU, one or more responses that include the respective one or more TA measurements; and
for each received TA measurement, determine a corresponding downlink (DL) propagation delay (PD) between the DU and the UE.

70. A distributed unit (DU) of a radio access network (RAN) node, the DU comprising:
communication interface circuitry configured to communicate with a centralized unit (CU) of the RAN node; and
processing circuitry operatively coupled to the communication interface circuitry, wherein the processing circuitry and the communication interface circuitry are configured to:
receive, from the CU, a request for one or more timing advance (TA) measurements for a user equipment (UE) with respect to one or more cells served by the DU;
obtain one or more TA measurements for the UE in accordance with the request; and
send, to the CU, one or more responses that include the respective one or more TA measurements.
